(19) United States
(12) Patent Application Publication
(10) Pub. No.: US 2024/0364445 A1
(43) Pub. Date: Oct. 31, 2024

(54) Proportional Round Robin Segment Parser Designs For Wider Bandwidths In Wireless Communications

(71) Applicant: MediaTek Inc., Hsinchu City (TW)

(72) Inventors: Shengquan Hu, San Jose, CA (US); Jianhan Liu, San Jose, CA (US); Thomas Edward Pare, JR., San Jose, CA (US)

(21) Appl. No.: 18/646,838

(22) Filed: Apr. 26, 2024

Related U.S. Application Data
(60) Provisional application No. 63/498,562, filed on Apr. 27, 2023.

(51) Int. Cl. H04L 1/00

(52) U.S. Cl. CPC H04L 1/0003; H04L 1/0033; H04L 1/0068

(57) ABSTRACT

Various schemes pertaining to proportional round robin segment parser designs for the wider bandwidths and corresponding multi-resource unit (MRU) combinations with either equal modulation (EQM) or unequal modulation (UEQM) in wireless communications are described. An apparatus (e.g., an access point (AP) or a non-AP station (STA)) generates a multi-resource unit (MRU) comprising an aggregate of a plurality of resource units (RUS). The apparatus then transmits the MRU with UEQM or EQM in a bandwidth of 480 MHz or greater.

### CROSS REFERENCE TO RELATED PATENT APPLICATION

The present disclosure is part of a non-provisional patent application claiming the priority benefit of U.S. Provisional Patent Application No. 63/498,562, filed 27 Apr. 2023, the content of which being incorporated by reference in its entirety.

### TECHNICAL FIELD

The present disclosure is generally related to wireless communications and, more particularly, to proportional round robin segment parser designs for wider bandwidths in wireless communications.

### BACKGROUND

Unless otherwise indicated herein, approaches described in this section are not prior art to the claims listed below and are not admitted as prior art by inclusion in this section.

In wireless communications such as Wi-Fi (or WiFi) and wireless local area network (WLAN) systems in accordance with one or more Institute of Electrical and Electronics Engineers (IEEE) 802.11be standards (e.g., IEEE 802.11ax/be), wider bandwidths, herein referring to bandwidths wider than 320 MHz such as 480 MHz and 640 MHz, have been proposed for system throughput improvement. Associated with these new/wider bandwidths, some new multi-resource unit (MRU) combinations are also considered. In a wider bandwidth, a user may transmit or may be assigned with resources across different power mode regions. To utilize the spectrum efficiently, scheduling different modulation and coding schemes (MCSs) or quadrature amplitude modulation (QAM) levels for different spectral resources may improve overall system throughput and link reliability. Moreover, system throughput and reliability may also be improved by assigning unequal modulations (UEQM) on resource units (RUs) of a given MRU. Therefore, there is a need for a solution of proportional round robin segment parser designs for the new wider bandwidths and new MRU combinations with either equal modulation (EQM) or unequal modulation (UEQM).

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to proportional round robin segment parser designs for the wider bandwidths and corresponding MRU combinations with either EQM or UEQM in wireless communications. Thus, implementation of one or more proportional round robin segment parser designs proposed herein may be utilized for EQM and/or UEQM for MRUs in the frequency domain. Furthermore, under the various schemes proposed herein, leftover bits may be processed in a proportional round robin fashion similar to that by a segment parser under IEEE 802.11be specification.

In one aspect, a method may involve generating an MRU comprising an aggregate of a plurality of RUs. The method may also involve transmitting the MRU with EQM or with UEQM in a bandwidth of 480 MHz or greater.

In another aspect, an apparatus may include a transceiver configured to communicate wirelessly and a processor coupled to the transceiver. The processor may generate an MRU comprising an aggregate of a plurality of RUs. The processor may also transmit, via the transceiver, the MRU with EQM or with UEQM in a bandwidth of 480 MHz or greater.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5th Generation (5G)/New Radio (NR), Long-Term Evolution (LTE), LTE-Advanced, LTE-Advanced Pro, Internet-of-Things (IoT), Industrial loT (IloT) and narrowband loT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example design under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example design under a proposed scheme in accordance with the present disclosure.

FIG. 6 is a diagram of an example design under a proposed scheme in accordance with the present disclosure.

FIG. 7 is a diagram of example scenario under a proposed scheme in accordance with the present disclosure.

FIG. 8 is a diagram of an example scenario under a proposed scheme in accordance with the present disclosure.

FIG. 9 is a diagram of an example scenario under a proposed scheme in accordance with the present disclosure.

FIG. 10 is a diagram of an example scenario under a proposed scheme in accordance with the present disclosure.

FIG. 11 is a diagram of an example scenario under a proposed scheme in accordance with the present disclosure.

FIG. 12 is a diagram of an example scenario under a proposed scheme in accordance with the present disclosure.

FIG. 13 is a diagram of an example scenario under a proposed scheme in accordance with the present disclosure.

FIG. 14 is a diagram of an example scenario under a proposed scheme in accordance with the present disclosure.

FIG. 15 is a diagram of example scenario under a proposed scheme in accordance with the present disclosure.

FIG. 16 is a diagram of an example scenario under a proposed scheme in accordance with the present disclosure.

FIG. 17 is a diagram of an example scenario under a proposed scheme in accordance with the present disclosure.

FIG. 18 is a diagram of an example scenario under a proposed scheme in accordance with the present disclosure.

FIG. 19 is a diagram of an example scenario under a proposed scheme in accordance with the present disclosure.

FIG. 20 is a diagram of an example scenario under a proposed scheme in accordance with the present disclosure.

FIG. 21 is a diagram of an example scenario under a proposed scheme in accordance with the present disclosure.

FIG. 22 is a diagram of an example scenario under a proposed scheme in accordance with the present disclosure.

FIG. 23 is a diagram of an example scenario under a proposed scheme in accordance with the present disclosure.

FIG. 24 is a diagram of an example scenario under a proposed scheme in accordance with the present disclosure.

FIG. 25 is a diagram of an example scenario under a proposed scheme in accordance with the present disclosure.

FIG. 26 is a block diagram of an example communication system under a proposed scheme in accordance with the present disclosure.

FIG. 27 is a flowchart of an example process under a proposed scheme in accordance with the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to proportional round robin segment parser designs for the wider bandwidths and corresponding MRU combinations with either EQM or UEQM in wireless communications. According to the present disclosure, a number of possible solutions may be implemented separately or jointly. That is, although these possible solutions may be described below separately, two or more of these possible solutions may be implemented in one combination or another.

It is noteworthy that, in the present disclosure, a regular RU (RRU or RU) refers to a RU with tones that are continuous (e.g., immediately adjacent to one another) and not interleaved, interlaced or otherwise distributed. Moreover, a 26-tone regular RU may be interchangeably denoted as RU26 (or RRU26), a 52-tone regular RU may be interchangeably denoted as RU52 (or RRU52), a 106-tone regular RU may be interchangeably denoted as RU106 (or RRU106), a 242-tone regular RU may be interchangeably denoted as RU242 (or RRU242), and so on. Moreover, an aggregate (26+52)-tone regular multi-RU (MRU) may be interchangeably denoted as MRU78 (or RMRU78), an aggregate (26+106)-tone regular MRU may be interchangeably denoted as MRU132 (or RMRU132), and so on. Furthermore, a distributed-tone RU (DRU) refers to a RU with tones that are non-discontinuous (e.g., not immediately adjacent to one another) and interleaved, interlaced or otherwise distributed. Accordingly, a 26-tone distributed-tone RU may be interchangeably denoted as DRU26, a 52-tone distributed-tone RU may be interchangeably denoted as DRU52, a 106-tone distributed-tone RU may be interchangeably denoted as DRU106, a 242-tone distributed-tone RU may be interchangeably denoted as DRU242, a 484-tone distributed-tone RU may be interchangeably denoted as DRU484, a 996-tone distributed-tone RU may be interchangeably denoted as DRU996, a 2×996-tone distributed-tone RU may be interchangeably denoted as DRU2x996, and so on.

It is also noteworthy that, in the present disclosure, a bandwidth of 20 MHz may be interchangeably denoted as BW20 or BW20M, a bandwidth of 40 MHz may be interchangeably denoted as BW40 or BW40M, a bandwidth of 80 MHz may be interchangeably denoted as BW80 or BW80M, a bandwidth of 160 MHz may be interchangeably denoted as BW160 or BW160M, a bandwidth of 240 MHz may be interchangeably denoted as BW240 or BW240M, a bandwidth of 320 MHz may be interchangeably denoted as BW320 or BW320M, a bandwidth of 480 MHz may be interchangeably denoted as BW480 or BW480M, a bandwidth of 500 MHz may be interchangeably denoted as BW500 or BW500M, a bandwidth of 520 MHz may be interchangeably denoted as BW520 or BW520M, a bandwidth of 540 MHz may be interchangeably denoted as BW540 or BW540M, a bandwidth of 640 MHz may be interchangeably denoted as BW640 or BW640M.

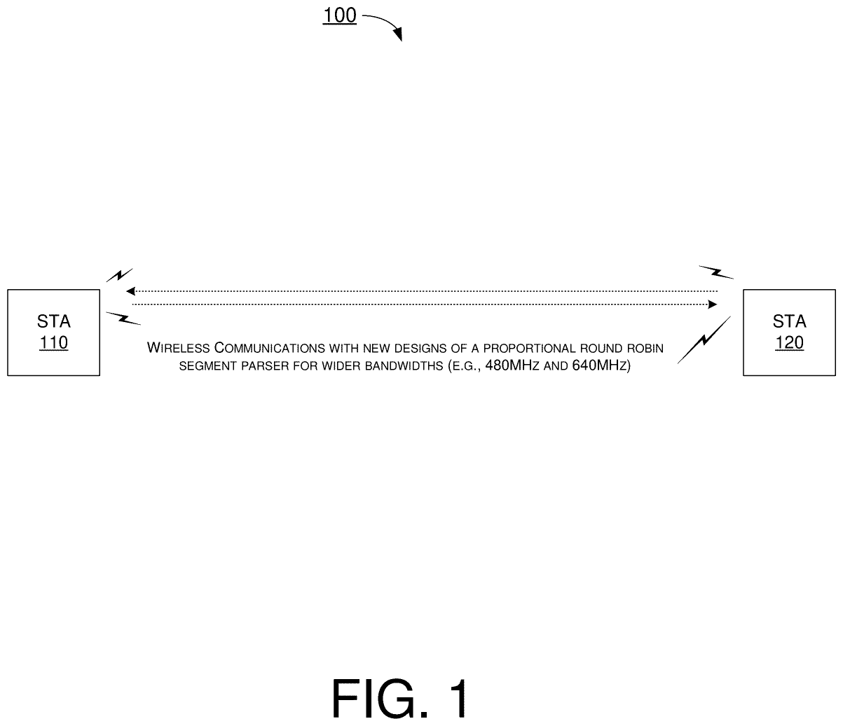

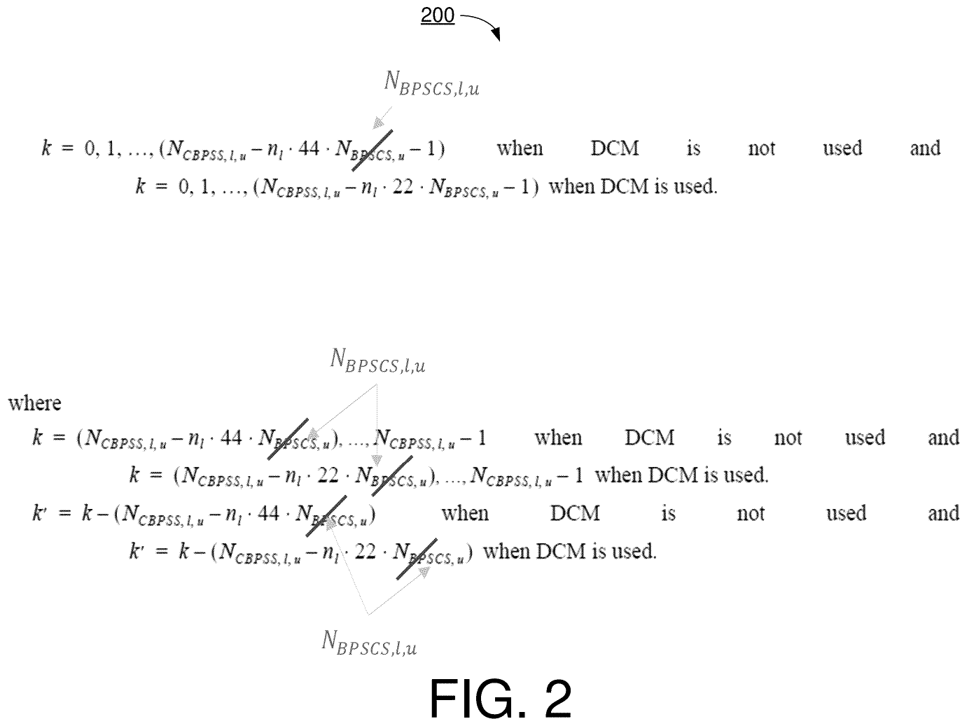

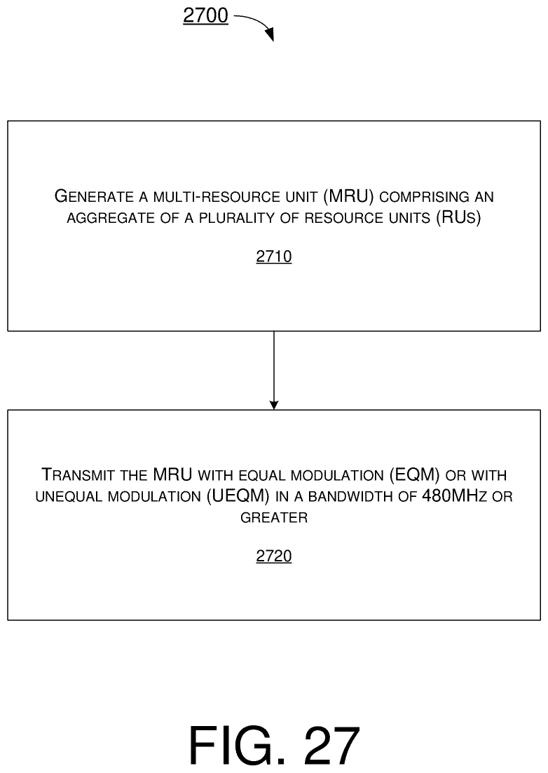

FIG. 1 illustrates an example network environment 100 in which various solutions and schemes in accordance with the present disclosure may be implemented. FIG. 2˜FIG. 27 illustrate examples of implementation of various proposed schemes in network environment 100 in accordance with the present disclosure. The following description of various proposed schemes is provided with reference to FIG. 1˜FIG. 27.

Referring to FIG. 1, network environment 100 may involve at least a station (STA) 110 communicating wirelessly with a STA 120. Either of STA 110 and STA 120 may be an access point (AP) STA or, alternatively, either of STA 110 and STA 120 may function as a non-AP STA. In some cases, STA 110 and STA 120 may be associated with a basic service set (BSS) in accordance with one or more IEEE 802.11 standards (e.g., IEEE 802.11be and future-developed standards). Each of STA 110 and STA 120 may be configured to communicate with each other by utilizing the proportional round robin segment parser designs for the wider bandwidths and corresponding MRU combinations with either EQM or UEQM in wireless communications in accordance with various proposed schemes described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In IEEE 802.11be, segment parsing may be performed for RUs and/or MRUs of sizes greater than a 996-tone RU (RU996), such as 2×996, 996+484, 996+484+242, 2×996+484, 3×996+484, and 4×996. The segment parser in wireless communications under IEEE 802.11be is operated for equal modulation across all the RUs in a given MRU, in that: s=max (1, N_{bpscs,u}/2) for user u, with the same s being used for all the RUs in a given MRU. Here, N_{BPSCS,u} denotes a number of coded bits per subcarrier per spatial stream for user u, N_{BPSCS,I,u} denotes a number of coded bits per subcarrier per spatial stream for frequency subblock index/for user u, and N_{CBPSS,I,u} denotes a number of coded bits per orthogonal frequency-division multiplexing (OFDM) symbol per spatial stream for frequency subblock index/for user u. The segment parser outputs a bit sequence distribution that can be expressed by Expression 1 as follows:

$${y}_{k , l , u} = {x}_{m , u} \\ m = ( {\sum }_{i = 0}^{L - 1} {m}_{i} ) \cdot ⌊ \frac{k}{{m}_{I}} ⌋ + {\sum }_{i = 0}^{I - 1} {m}_{i} + ( k mod {m}_{I} )$$

If there are leftover bits, the leftover bits may be processed in a round robin fashion as shown in Expression 2 below (which may be reused for UEQM):

$$m = ( {\sum }_{i = 0}^{L - 1} {m}_{i} ) \cdot ⌊ \frac{{N}_{CBPSS , {I}_{0} , u}}{{m}_{{I}_{0}}} ⌋ + ( {\sum }_{i = 0 , i \neq {I}_{0}}^{L - 1} {m}_{i} ) \cdot ⌊ \frac{{k}^{′}}{{m}_{I}} ⌋ + {\sum }_{i = 0 , i \neq {I}_{0}}^{I - 1} {m}_{i} + ( k mod {m}_{I} )$$

Under various proposed schemes in accordance with the present disclosure, the processing for EQM and UEQM for wider bandwidths (e.g., 480 MHz and 640 MHz) by a proportional round robin segment parser may be operated the same as the segment parser under IEEE 802.11be as described above. That is, the formulae/equations of segment parsing in IEEE 802.11be may be reused with minor modifications by replacing all instances of N_{BPSCS,u} with N_{BPSCS,I,u} for UEQM, where/denotes the frequency segment or subblock index. Under the proposed schemes, N_{BPSCS,I,u} may be associated with different modulations in different RUs in different frequency segments/frequency subblocks.

FIG. 2 illustrates an example scenario 200 under a proposed scheme in accordance with the present disclosure. Scenario 200 may pertain to modifications of an IEEE 802.11be segment parser processing for UEQM. Under the proposed scheme, the segment parser processing for UEQM may be operated in a way that is the same as that under IEEE 802.11be. Thus, Expression 1 shown above of segment parser in IEEE 802.11be may be reused with minor modifications by replacing all N_{BPSCS,u} with N_{BPSCS,I,u}. Here, I denotes a frequency segment or subblock index and N_{BPSCS,I} denotes a number of coded bits per subcarrier spacing for a respective frequency segment or subblock index for user u. Under the proposed scheme, N_{BPSCS,I,u} may be associated with different modulations in different RUs/MRUs in different frequency segments or frequency subblocks. Similarly, Expression 2 shown above may be reused for processing leftover bits for UEQM. FIG. 2 shows the minor modifications made to an IEEE 802.11be segment parser for supporting UEQM. In FIG. 2, the term “DCM” refers to dual-carrier modulation.

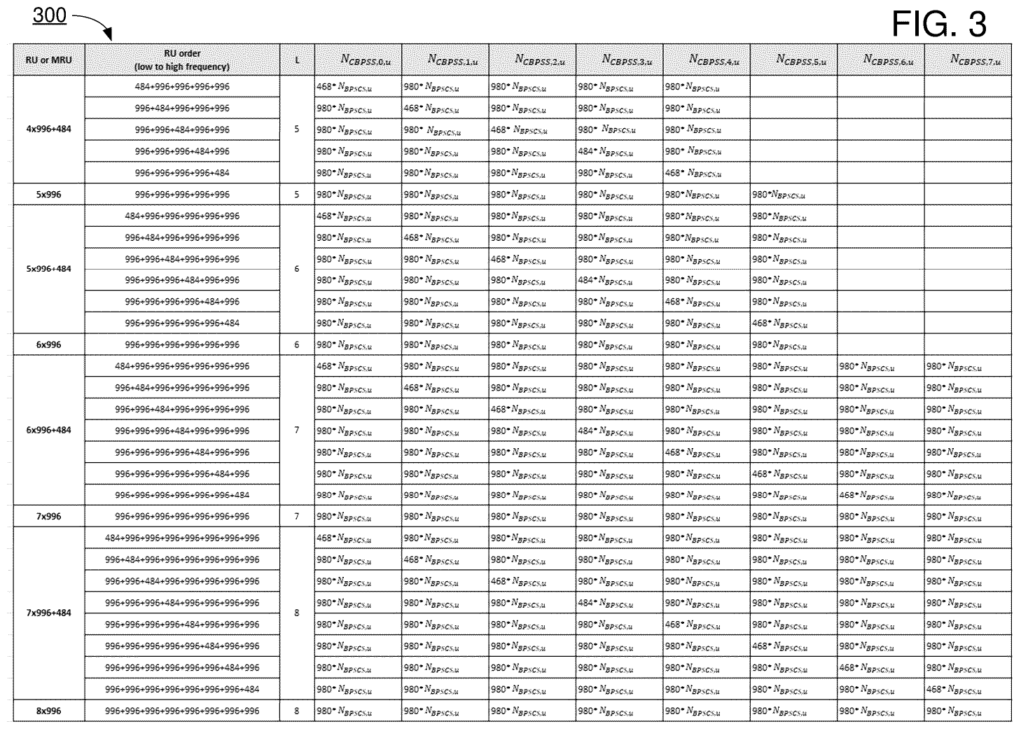

FIG. 3 illustrates an example design 300 under a proposed scheme in accordance with the present disclosure. Design 300 may pertain to physical-layer parameters N_{CBPSS,I,u} (number of coded bits per OFDM symbol per spatial stream) for a proportional round robin segment parser used for EQM. Here, L denotes a number of 80 MHz frequency segments or frequency subblocks utilized or otherwise occupied by RUs of the respective MRU, I denotes a frequency segment or subblock index (with/=0, 1, . . . 7), and N_{CBPSS,I,u} denotes a number of coded bits per OFDM symbol per spatial stream for a respective frequency segment or subblock index/for user u.

Referring to FIG. 3, a proportional round robin segment parser in design 300 may be utilized for wireless communications in a wider bandwidth with different MRUs using EQM. For instance, data tones of MRU(4×996+484) may be proportionally distributed over five 80 MHz frequency segments or frequency subblocks (e.g., 468 data tones for the 484-tone RU of the MRU distributed in one 80 MHz frequency segment/frequency subblock and 980 data tones for each of the four 996-tone RUs of the MRU distributed in a respective one of other four 80 MHz frequency segments/frequency subblocks) with EQM applied to each of the five 80 MHz frequency segments or frequency subblocks. Data tones of MRU(5×996) may be proportionally distributed over five 80 MHz frequency segments or frequency subblocks (e.g., 980 data tones for each of the five 996-tone RUs of the MRU distributed in a respective one of five 80 MHz frequency segments/frequency subblocks) with EQM applied to each of the five 80 MHz frequency segments or frequency subblocks. Data tones of MRU(5×996+484) may be proportionally distributed over six 80 MHz frequency segments or frequency subblocks (e.g., 468 data tones for the 484-tone RU of the MRU distributed in one 80 MHz frequency segment/frequency subblock and 980 data tones for each of the five 996-tone RUs of the MRU distributed in a respective one of other five 80 MHz frequency segments/frequency subblocks) with EQM applied to each of the six 80 MHz frequency segments or frequency subblocks. Data tones of MRU(6×996) may be proportionally distributed over six 80 MHz frequency segments or frequency subblocks (e.g., 980 data tones for each of the six 996-tone RUs of the MRU distributed in a respective one of six 80 MHz frequency segments/frequency subblocks) with EQM applied to each of the six 80 MHz frequency segments or frequency subblocks. Data tones of MRU(6×996+484) may be proportionally distributed over seven 80 MHz frequency segments or frequency subblocks (e.g., 468 data tones for the 484-tone RU of the MRU distributed in one 80 MHz frequency segment/frequency subblock and 980 data tones for each of the six 996-tone RUs of the MRU distributed in a respective one of other six 80 MHz frequency segments/frequency subblocks) with EQM applied to each of the seven 80 MHz frequency segments or frequency subblocks. Data tones of MRU(7×996) may be proportionally distributed over seven 80 MHz frequency segments or frequency subblocks (e.g., 980 data tones for each of the seven 996-tone RUs of the MRU distributed in a respective one of seven 80 MHz frequency segments/frequency subblocks) with EQM applied to each of the seven 80 MHz frequency segments or frequency subblocks. Data tones of MRU(7×996+484) may be proportionally distributed over eight 80 MHz frequency segments or frequency subblocks (e.g., 468 data tones for the 484-tone RU of the MRU distributed in one 80 MHz frequency segment/frequency subblock and 980 data tones for each of the seven 996-tone RUs of the MRU distributed in a respective one of other seven 80 MHz frequency segments/frequency subblocks) with EQM applied to each of the eight 80 MHz frequency segments or frequency subblocks. Data tones of MRU(8×996) may be proportionally distributed over eight 80 MHz frequency segments or frequency subblocks (e.g., 980 data tones for each of the eight 996-tone RUs of the MRU distributed in a respective one of eight 80 MHz frequency segments/frequency subblocks) with EQM applied to each of the eight 80 MHz frequency segments or frequency subblocks.

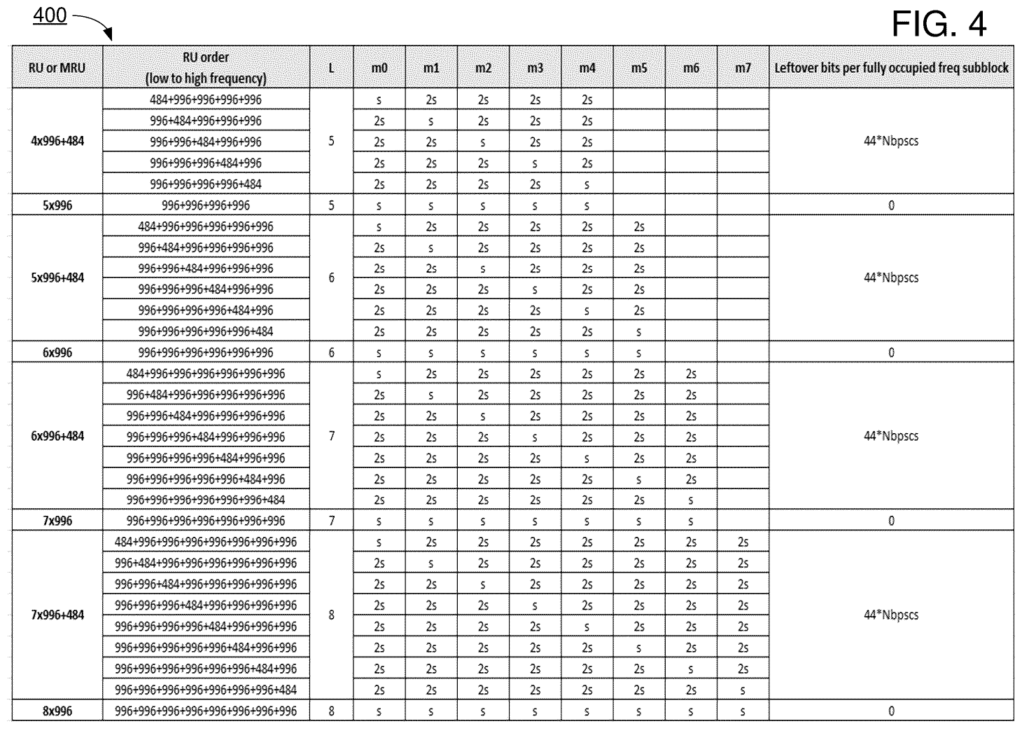

FIG. 4 illustrates an example design 400 under a proposed scheme in accordance with the present disclosure. Design 400 may pertain to physical-layer parameters m0˜m7 (representative of ratios of numbers of coded bits per symbol per spatial stream among different frequency segments/frequency subblocks) for a proportional round robin segment parser used for EQM. Here, L denotes a number of 80 MHz frequency segments or frequency subblocks utilized or otherwise occupied by RUs of the respective MRU.

Referring to FIG. 4, a proportional round robin segment parser in design 300 may be utilized for wireless communications in a wider bandwidth with different MRUs using EQM. For instance, data tones of MRU(4×996+484) may be proportionally distributed over five 80 MHz frequency segments or frequency subblocks (e.g., a ratio of s data tones for the 484-tone RU of the MRU distributed in one 80 MHz frequency segment/frequency subblock and a ratio of 2s data tones for each of the four 996-tone RUs of the MRU distributed in a respective one of other four 80 MHz frequency segments/frequency subblocks) with EQM applied to each of the five 80 MHz frequency segments or frequency subblocks and with a number of leftover bits per fully occupied frequency segment/frequency subblock=44*N_{BPSCS}. Data tones of MRU(5×996) may be proportionally distributed over five 80 MHz frequency segments or frequency subblocks (e.g., a ratio of s data tones for each of the five 996-tone RUs of the MRU distributed in a respective one of five 80 MHz frequency segments/frequency subblocks) with EQM applied to each of the five 80 MHz frequency segments or frequency subblocks and with no leftover bits. Data tones of MRU(5×996+484) may be proportionally distributed over six 80 MHz frequency segments or frequency subblocks (e.g., a ratio of s data tones for the 484-tone RU of the MRU distributed in one 80 MHz frequency segment/frequency subblock and a ratio of 2s data tones for each of the five 996-tone RUs of the MRU distributed in a respective one of other five 80 MHz frequency segments/frequency subblocks) with EQM applied to each of the six 80 MHz frequency segments or frequency subblocks and with a number of leftover bits per fully occupied frequency segment/frequency subblock=44*N_{BPSCS}. Data tones of MRU(6×996) may be proportionally distributed over six 80 MHz frequency segments or frequency subblocks (e.g., a ratio of s data tones for each of the six 996-tone RUs of the MRU distributed in a respective one of six 80 MHz frequency segments/frequency subblocks) with EQM applied to each of the six 80 MHz frequency segments or frequency subblocks and with no leftover bits. Data tones of MRU(6×996+484) may be proportionally distributed over seven 80 MHz frequency segments or frequency subblocks (e.g., a ratio of s data tones for the 484-tone RU of the MRU distributed in one 80 MHz frequency segment/frequency subblock and a ratio of 2s data tones for each of the six 996-tone RUs of the MRU distributed in a respective one of other six 80 MHz frequency segments/frequency subblocks) with EQM applied to each of the seven 80 MHz frequency segments or frequency subblocks and with a number of leftover bits per fully occupied frequency segment/frequency subblock=44*N_{BPSCS}. Data tones of MRU(7×996) may be proportionally distributed over seven 80 MHz frequency segments or frequency subblocks (e.g., a ratio of s data tones for each of the seven 996-tone RUs of the MRU distributed in a respective one of seven 80 MHz frequency segments/frequency subblocks) with EQM applied to each of the seven 80 MHz frequency segments or frequency subblocks and with no leftover bits. Data tones of MRU(7×996+484) may be proportionally distributed over eight 80 MHz frequency segments or frequency subblocks (e.g., a ratio of s data tones for the 484-tone RU of the MRU distributed in one 80 MHz frequency segment/frequency subblock and a ratio of 2s data tones for each of the seven 996-tone RUs of the MRU distributed in a respective one of other seven 80 MHz frequency segments/frequency subblocks) with EQM applied to each of the eight 80 MHz frequency segments or frequency subblocks and with a number of leftover bits per fully occupied frequency segment/frequency subblock=44*N_{BPSCS}. Data tones of MRU(8×996) may be proportionally distributed over eight 80 MHz frequency segments or frequency subblocks (e.g., a ratio of s data tones for each of the eight 996-tone RUs of the MRU distributed in a respective one of eight 80 MHz frequency segments/frequency subblocks) with EQM applied to each of the eight 80 MHz frequency segments or frequency subblocks and with no leftover bits. Here, N_{BPSCS} denotes a number of coded bits per subcarrier per spatial stream.

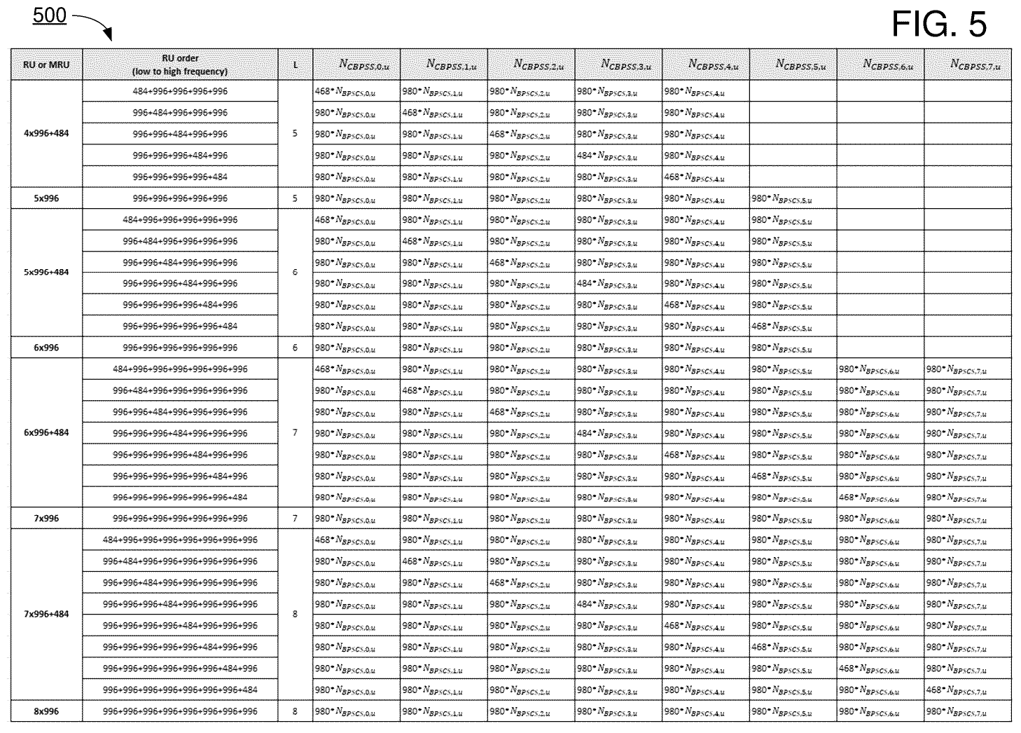

FIG. 5 illustrates an example design 500 under a proposed scheme in accordance with the present disclosure. Design 500 may pertain to physical-layer parameters N_{CBPSS,I,u} (number of coded bits per OFDM symbol per spatial stream) for a proportional round robin segment parser used for UEQM. That is, the modulation of a given RU of an MRU over a respective 80 MHz frequency segment/frequency subblock may be frequency segment or subblock index dependent. Here, L denotes a number of 80 MHz frequency segments or frequency subblocks utilized or otherwise occupied by RUs of the respective MRU, I denotes a frequency segment or subblock index (with/=0, 1, . . . 7), and N_{CBPSS,I,u} denotes a number of coded bits per OFDM symbol per spatial stream for a respective frequency segment or subblock index/for user u, N_{BPSCS,I,u} denotes a number of coded bits per subcarrier per spatial stream for a respective frequency segment or subblock index/for user u.

Referring to FIG. 5, a proportional round robin segment parser in design 300 may be utilized for wireless communications in a wider bandwidth with different MRUs using UEQM. For instance, data tones of MRU(4×996+484) may be proportionally distributed over five 80 MHz frequency segments or frequency subblocks (e.g., 468 data tones for the 484-tone RU of the MRU distributed in one 80 MHz frequency segment/frequency subblock and 980 data tones for each of the four 996-tone RUs of the MRU distributed in a respective one of other four 80 MHz frequency segments/frequency subblocks) with UEQM applied to the five 80 MHz frequency segments or frequency subblocks (e.g., one of the RUs of the MRU may be modulated differently than another RU of the MRU). Data tones of MRU(5×996) may be proportionally distributed over five 80 MHz frequency segments or frequency subblocks (e.g., 980 data tones for each of the five 996-tone RUs of the MRU distributed in a respective one of five 80 MHz frequency segments/frequency subblocks) with UEQM applied to the five 80 MHz frequency segments or frequency subblocks (e.g., one of the RUs of the MRU may be modulated differently than another RU of the MRU). Data tones of MRU(5×996+484) may be proportionally distributed over six 80 MHz frequency segments or frequency subblocks (e.g., 468 data tones for the 484-tone RU of the MRU distributed in one 80 MHz frequency segment/frequency subblock and 980 data tones for each of the five 996-tone RUs of the MRU distributed in a respective one of other five 80 MHz frequency segments/frequency subblocks) with UEQM applied to the five 80 MHz frequency segments or frequency subblocks (e.g., one of the RUs of the MRU may be modulated differently than another RU of the MRU). Data tones of MRU(6×996) may be proportionally distributed over six 80 MHz frequency segments or frequency subblocks (e.g., 980 data tones for each of the six 996-tone RUs of the MRU distributed in a respective one of six 80 MHz frequency segments/frequency subblocks) with UEQM applied to the five 80 MHz frequency segments or frequency subblocks (e.g., one of the RUs of the MRU may be modulated differently than another RU of the MRU). Data tones of MRU(6×996+484) may be proportionally distributed over seven 80 MHz frequency segments or frequency subblocks (e.g., 468 data tones for the 484-tone RU of the MRU distributed in one 80 MHz frequency segment/frequency subblock and 980 data tones for each of the six 996-tone RUs of the MRU distributed in a respective one of other six 80 MHz frequency segments/frequency subblocks) with UEQM applied to the five 80 MHz frequency segments or frequency subblocks (e.g., one of the RUs of the MRU may be modulated differently than another RU of the MRU). Data tones of MRU(7×996) may be proportionally distributed over seven 80 MHz frequency segments or frequency subblocks (e.g., 980 data tones for each of the seven 996-tone RUs of the MRU distributed in a respective one of seven 80 MHz frequency segments/frequency subblocks) with UEQM applied to the five 80 MHz frequency segments or frequency subblocks (e.g., one of the RUs of the MRU may be modulated differently than another RU of the MRU). Data tones of MRU(7×996+484) may be proportionally distributed over eight 80 MHz frequency segments or frequency subblocks (e.g., 468 data tones for the 484-tone RU of the MRU distributed in one 80 MHz frequency segment/frequency subblock and 980 data tones for each of the seven 996-tone RUs of the MRU distributed in a respective one of other seven 80 MHz frequency segments/frequency subblocks) with UEQM applied to the five 80 MHz frequency segments or frequency subblocks (e.g., one of the RUs of the MRU may be modulated differently than another RU of the MRU). Data tones of MRU(8×996) may be proportionally distributed over eight 80 MHz frequency segments or frequency subblocks (e.g., 980 data tones for each of the eight 996-tone RUs of the MRU distributed in a respective one of eight 80 MHz frequency segments/frequency subblocks) with UEQM applied to the five 80 MHz frequency segments or frequency subblocks (e.g., one of the RUs of the MRU may be modulated differently than another RU of the MRU).

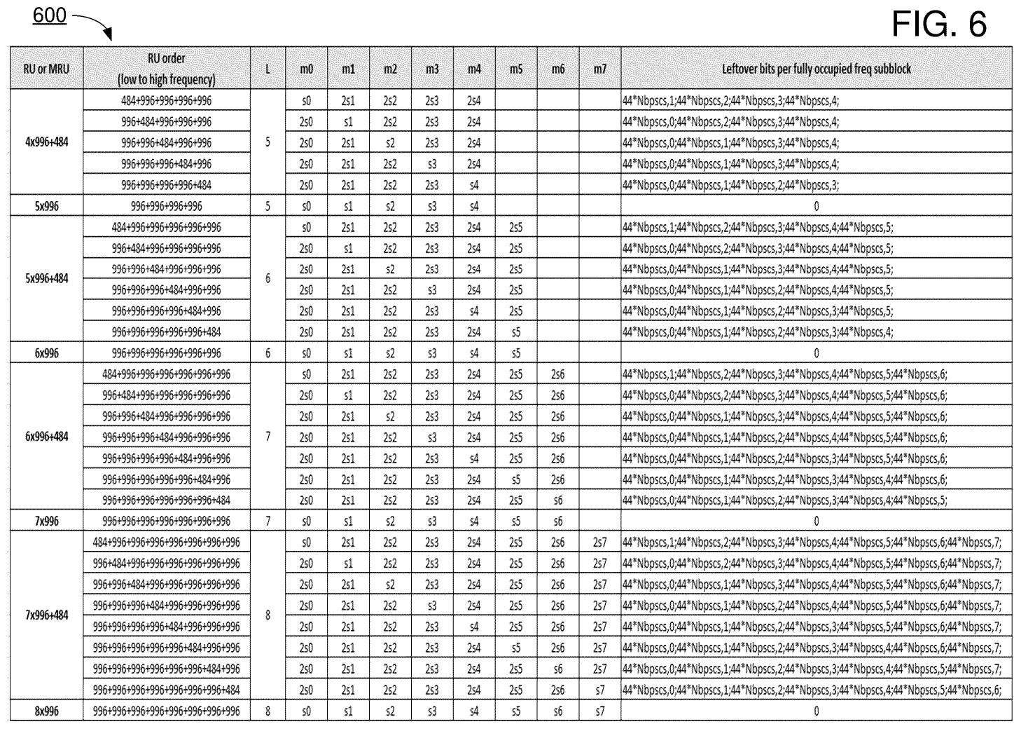

FIG. 6 illustrates an example design 600 under a proposed scheme in accordance with the present disclosure. Design 600 may pertain to physical-layer parameters m0˜m7 (representative of ratios of numbers of coded bits per symbol per spatial stream among different frequency segments/frequency subblocks) for a proportional round robin segment parser used for UEQM. That is, the modulation of a given RU of an MRU over a respective 80 MHz frequency segment/frequency subblock may be frequency segment or subblock index dependent. Here, L denotes a number of 80 MHz frequency segments or frequency subblocks utilized or otherwise occupied by RUs of the respective MRU, I denotes a frequency segment or subblock index (with I=0, 1, . . . 7), and N_{bpscs,I,} denotes a number of coded bits per subcarrier per spatial stream for a respective frequency segment or subblock index I. Moreover, s_{I}=max(1, N_{bpscs,I}/2).

Referring to FIG. 6, a proportional round robin segment parser in design 300 may be utilized for wireless communications in a wider bandwidth with different MRUs using UEQM. For instance, data tones of MRU(4×996+484) may be proportionally distributed over five 80 MHz frequency segments or frequency subblocks (e.g., a ratio of s_{I} data tones for the 484-tone RU of the MRU distributed in one 80 MHz frequency segment/frequency subblock and a ratio of 2s/data tones for each of the four 996-tone RUs of the MRU distributed in a respective one of other four 80 MHz frequency segments/frequency subblocks) with UEQM applied to each of the five 80 MHz frequency segments or frequency subblocks (e.g., one of the RUs of the MRU may be modulated differently than another RU of the MRU) and with a number of leftover bits per fully occupied frequency segment/frequency subblock=44*N_{BPSCS,I}. Data tones of MRU(5×996) may be proportionally distributed over five 80 MHz frequency segments or frequency subblocks (e.g., a ratio of s/data tones for each of the five 996-tone RUs of the MRU distributed in a respective one of five 80 MHz frequency segments/frequency subblocks) with UEQM applied to each of the five 80 MHz frequency segments or frequency subblocks (e.g., one of the RUs of the MRU may be modulated differently than another RU of the MRU) and with no leftover bits. Data tones of MRU(5×996+484) may be proportionally distributed over six 80 MHz frequency segments or frequency subblocks (e.g., a ratio of s/data tones for the 484-tone RU of the MRU distributed in one 80 MHz frequency segment/frequency subblock and a ratio of 2s/data tones for each of the five 996-tone RUs of the MRU distributed in a respective one of other five 80 MHz frequency segments/frequency subblocks) with UEQM applied to each of the six 80 MHz frequency segments or frequency subblocks (e.g., one of the RUs of the MRU may be modulated differently than another RU of the MRU) and with a number of leftover bits per fully occupied frequency segment/frequency subblock=44*N_{BPSCS,I}. Data tones of MRU(6×996) may be proportionally distributed over six 80 MHz frequency segments or frequency subblocks (e.g., a ratio of s_{I} data tones for each of the six 996-tone RUs of the MRU distributed in a respective one of six 80 MHz frequency segments/frequency subblocks) with UEQM applied to each of the six 80 MHz frequency segments or frequency subblocks (e.g., one of the RUs of the MRU may be modulated differently than another RU of the MRU) and with no leftover bits. Data tones of MRU(6×996+484) may be proportionally distributed over seven 80 MHz frequency segments or frequency subblocks (e.g., a ratio of s/data tones for the 484-tone RU of the MRU distributed in one 80 MHz frequency segment/frequency subblock and a ratio of 2s/data tones for each of the six 996-tone RUs of the MRU distributed in a respective one of other six 80 MHz frequency segments/frequency subblocks) with UEQM applied to each of the seven 80 MHz frequency segments or frequency subblocks (e.g., one of the RUs of the MRU may be modulated differently than another RU of the MRU) and with a number of leftover bits per fully occupied frequency segment/frequency subblock=44*N_{BPSCS},I. Data tones of MRU(7×996) may be proportionally distributed over seven 80 MHz frequency segments or frequency subblocks (e.g., a ratio of s/data tones for each of the seven 996-tone RUs of the MRU distributed in a respective one of seven 80 MHz frequency segments/frequency subblocks) with UEQM applied to each of the seven 80 MHz frequency segments or frequency subblocks (e.g., one of the RUs of the MRU may be modulated differently than another RU of the MRU) and with no leftover bits. Data tones of MRU(7×996+484) may be proportionally distributed over eight 80 MHz frequency segments or frequency subblocks (e.g., a ratio of s_{I} data tones for the 484-tone RU of the MRU distributed in one 80 MHz frequency segment/frequency subblock and a ratio of 2s/data tones for each of the seven 996-tone RUs of the MRU distributed in a respective one of other seven 80 MHz frequency segments/frequency subblocks) with UEQM applied to each of the eight 80 MHz frequency segments or frequency subblocks (e.g., one of the RUs of the MRU may be modulated differently than another RU of the MRU) and with a number of leftover bits per fully occupied frequency segment/frequency subblock=44*N_{BPSCS,I}. Data tones of MRU(8×996) may be proportionally distributed over eight 80 MHz frequency segments or frequency subblocks (e.g., a ratio of s/data tones for each of the eight 996-tone RUs of the MRU distributed in a respective one of eight 80 MHz frequency segments/frequency subblocks) with UEQM applied to each of the eight 80 MHz frequency segments or frequency subblocks (e.g., one of the RUs of the MRU may be modulated differently than another RU of the MRU) and with no leftover bits. Here, N_{BPSCS,I} denotes a number of coded bits per subcarrier per spatial stream for a respective frequency segment or subblock index I.

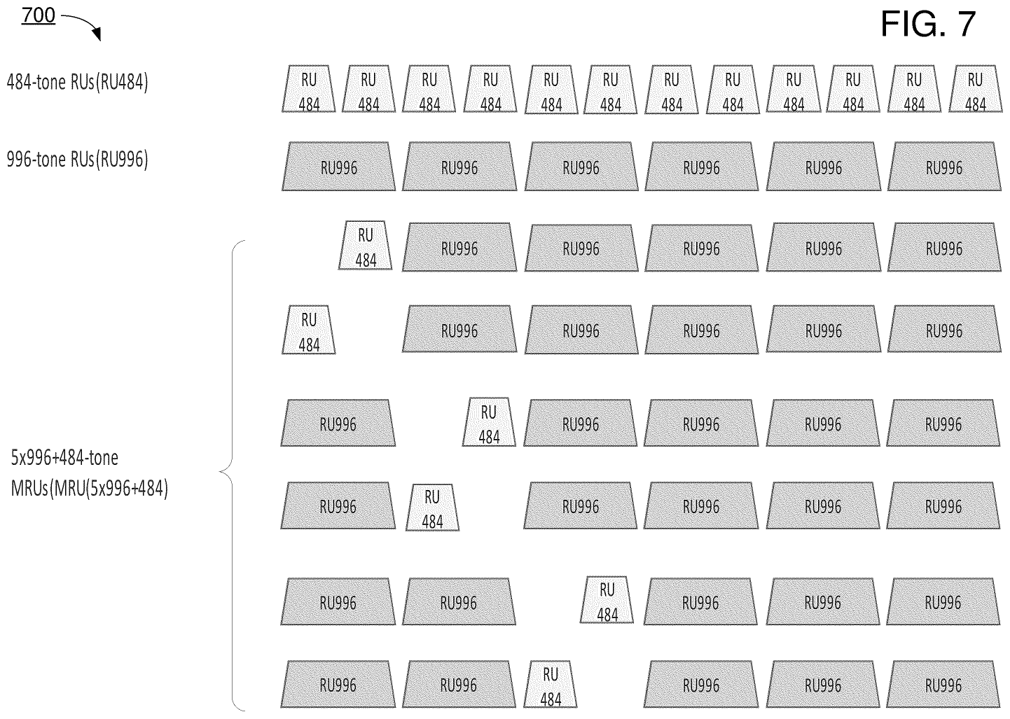

FIG. 7 illustrates an example scenario 700 under a proposed scheme in accordance with the present disclosure. Scenario 700 may pertain to MRU combination options for a wider bandwidth of 480 MHz. It is noteworthy that MRU combinations with either a one-hole puncture (e.g., one continuous puncture) or two-hole punctures (e.g., two discontinuous punctures) are considered and may be utilized under the proposed scheme. Referring to FIG. 7, in one option, upon to twelve 484-tone RUs may be modulated and transmitted over a 480 MHz bandwidth, with each RU484 occupying a respective 40 MHz frequency segment/frequency subblock. In another option, upon to six 996-tone RUs may be modulated and transmitted over the 480 MHz bandwidth, with each RU996 occupying a respective 80 MHz frequency segment/frequency subblock. In other options, MRU(5×996+484) may be modulated and transmitted over the 480 MHz bandwidth, with the RU484 occupying a respective 40 MHz frequency segment/frequency subblock and with each RU996 occupying a respective 80 MHz frequency segment/frequency subblock, resulting in a one-hole (40 MHz) puncture.

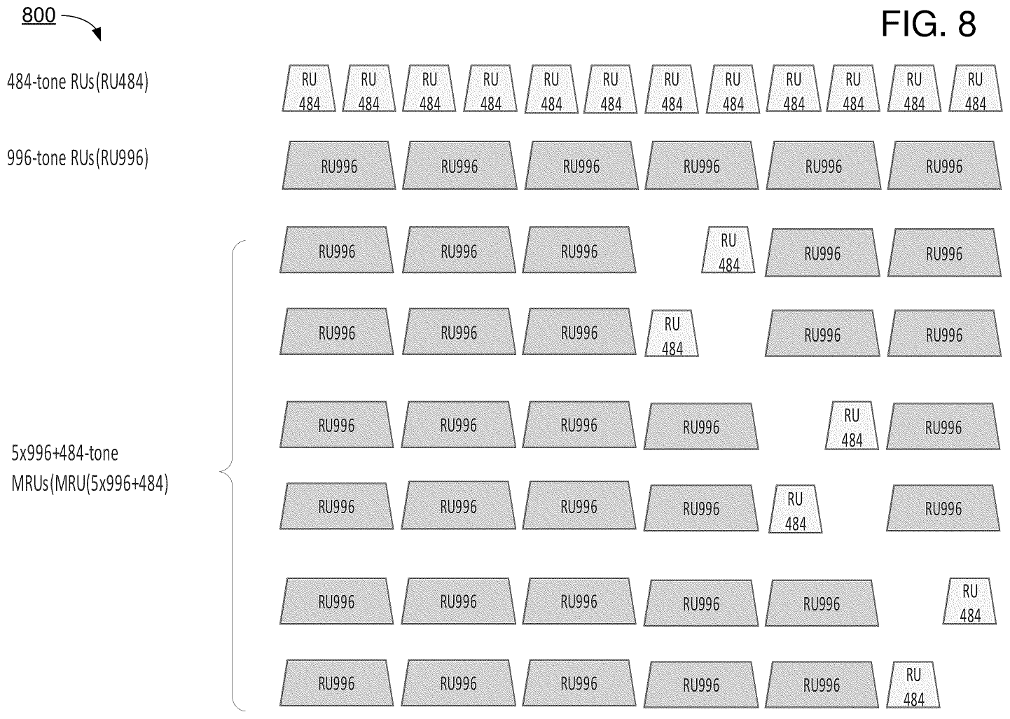

FIG. 8 illustrates an example scenario 800 under a proposed scheme in accordance with the present disclosure. Scenario 800 may pertain to MRU combination options for a wider bandwidth of 480 MHz. It is noteworthy that MRU combinations with either a one-hole puncture or two-hole punctures are considered and may be utilized under the proposed scheme. Referring to FIG. 8, in one option, upon to twelve 484-tone RUs may be modulated and transmitted over a 480 MHz bandwidth, with each RU484 occupying a respective 40 MHz frequency segment/frequency subblock. In another option, upon to six 996-tone RUs may be modulated and transmitted over the 480 MHz bandwidth, with each RU996 occupying a respective 80 MHz frequency segment/frequency subblock. In other options, MRU(5×996+484) may be modulated and transmitted over the 480 MHz bandwidth, with the RU484 occupying a respective 40 MHz frequency segment/frequency subblock and with each RU996 occupying a respective 80 MHz frequency segment/frequency subblock, resulting in a one-hole (40 MHz) puncture.

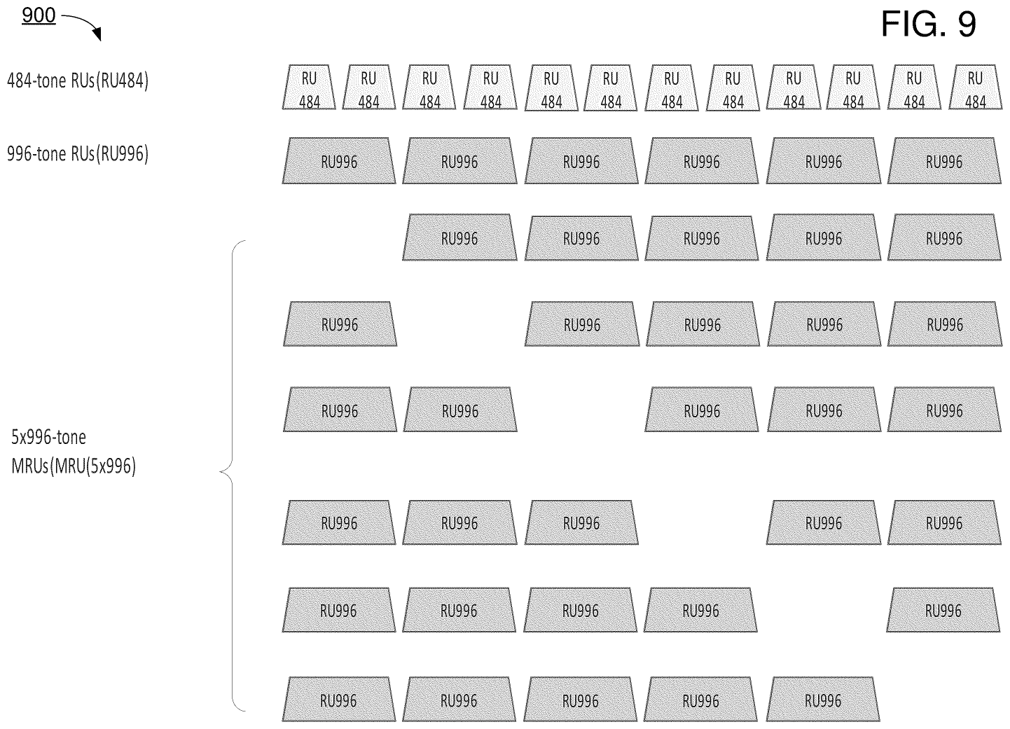

FIG. 9 illustrates an example scenario 900 under a proposed scheme in accordance with the present disclosure. Scenario 900 may pertain to MRU combination options for a wider bandwidth of 480 MHz. It is noteworthy that MRU combinations with either a one-hole puncture or two-hole punctures are considered and may be utilized under the proposed scheme. Referring to FIG. 9, in one option, upon to twelve 484-tone RUs may be modulated and transmitted over a 480 MHz bandwidth, with each RU484 occupying a respective 40 MHz frequency segment/frequency subblock. In another option, upon to six 996-tone RUs may be modulated and transmitted over the 480 MHz bandwidth, with each RU996 occupying a respective 80 MHz frequency segment/frequency subblock. In other options, MRU(5×996) may be modulated and transmitted over the 480 MHz bandwidth, with each RU996 occupying a respective 80 MHz frequency segment/frequency subblock, resulting in a one-hole (80 MHz) puncture.

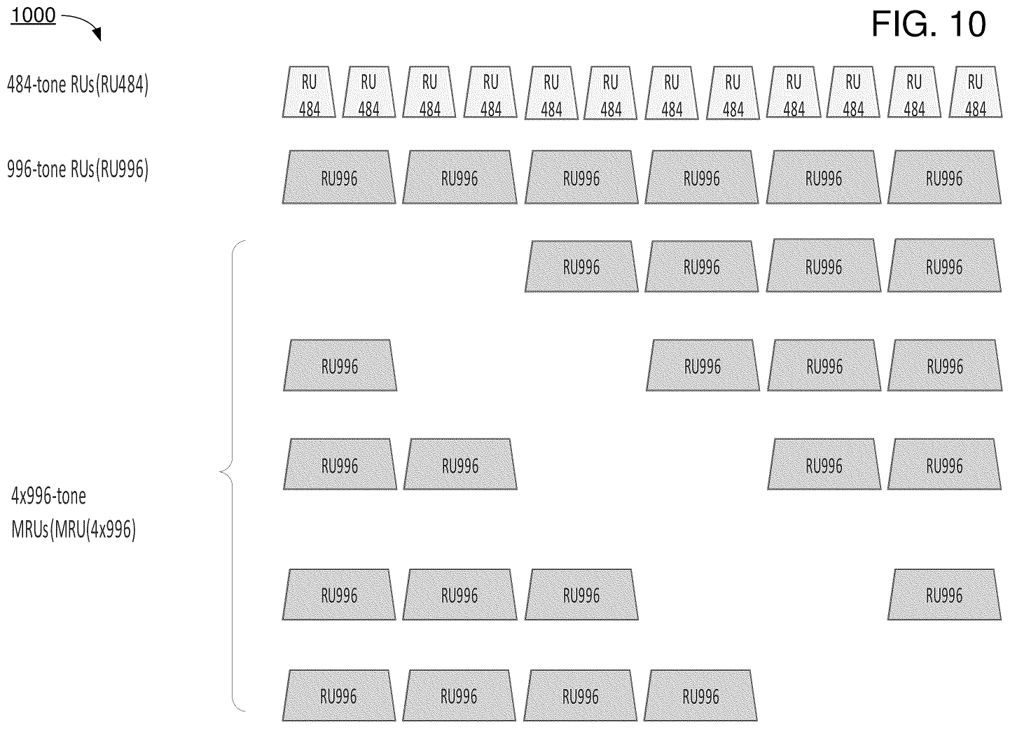

FIG. 10 illustrates an example scenario 1000 under a proposed scheme in accordance with the present disclosure. Scenario 1000 may pertain to MRU combination options for a wider bandwidth of 480 MHz. It is noteworthy that MRU combinations with either a one-hole puncture or two-hole punctures are considered and may be utilized under the proposed scheme. Referring to FIG. 10, in one option, upon to twelve 484-tone RUs may be modulated and transmitted over a 480 MHz bandwidth, with each RU484 occupying a respective 40 MHz frequency segment/frequency subblock. In another option, upon to six 996-tone RUs may be modulated and transmitted over the 480 MHz bandwidth, with each RU996 occupying a respective 80 MHz frequency segment/frequency subblock. In other options, MRU(4×996) may be modulated and transmitted over the 480 MHz bandwidth, with each RU996 occupying a respective 80 MHz frequency segment/frequency subblock, resulting in a one-hole (160 MHz) puncture.

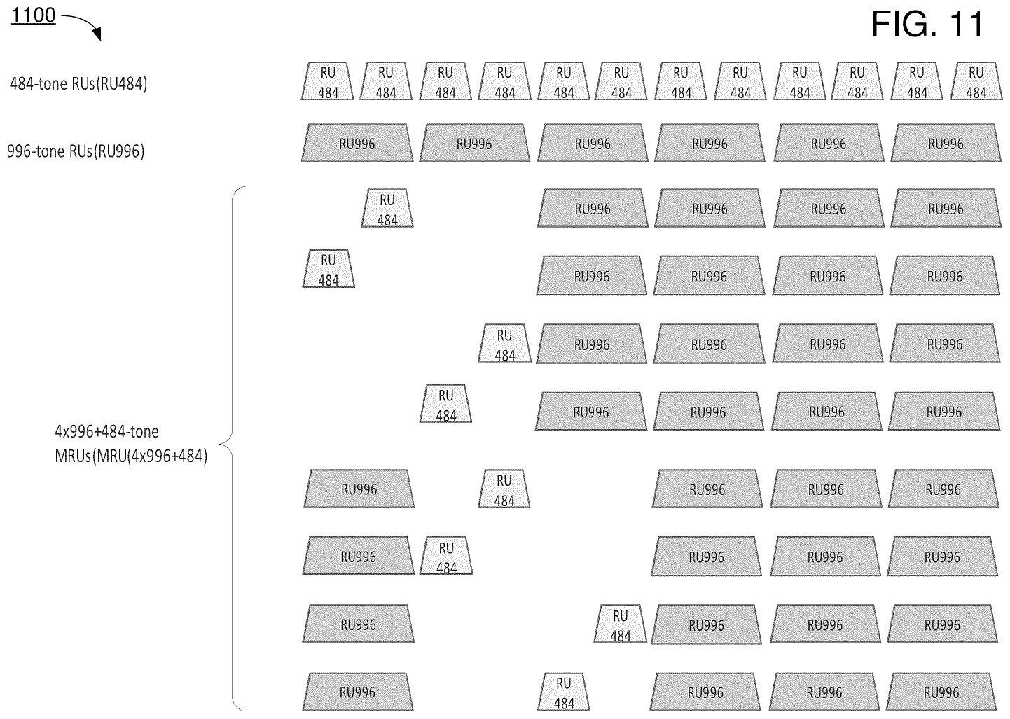

FIG. 11 illustrates an example scenario 1100 under a proposed scheme in accordance with the present disclosure. Scenario 1100 may pertain to MRU combination options for a wider bandwidth of 480 MHz. It is noteworthy that MRU combinations with either a one-hole puncture or two-hole punctures are considered and may be utilized under the proposed scheme. Referring to FIG. 11, in one option, upon to twelve 484-tone RUs may be modulated and transmitted over a 480 MHz bandwidth, with each RU484 occupying a respective 40 MHz frequency segment/frequency subblock. In another option, upon to six 996-tone RUs may be modulated and transmitted over the 480 MHz bandwidth, with each RU996 occupying a respective 80 MHz frequency segment/frequency subblock. In other options, MRU(4×996+484) may be modulated and transmitted over the 480 MHz bandwidth, with the RU484 occupying a respective 40 MHz frequency segment/frequency subblock and with each RU996 occupying a respective 80 MHz frequency segment/frequency subblock, resulting in a two-hole puncture of one 40 MHz puncture plus one 80 MHz puncture.

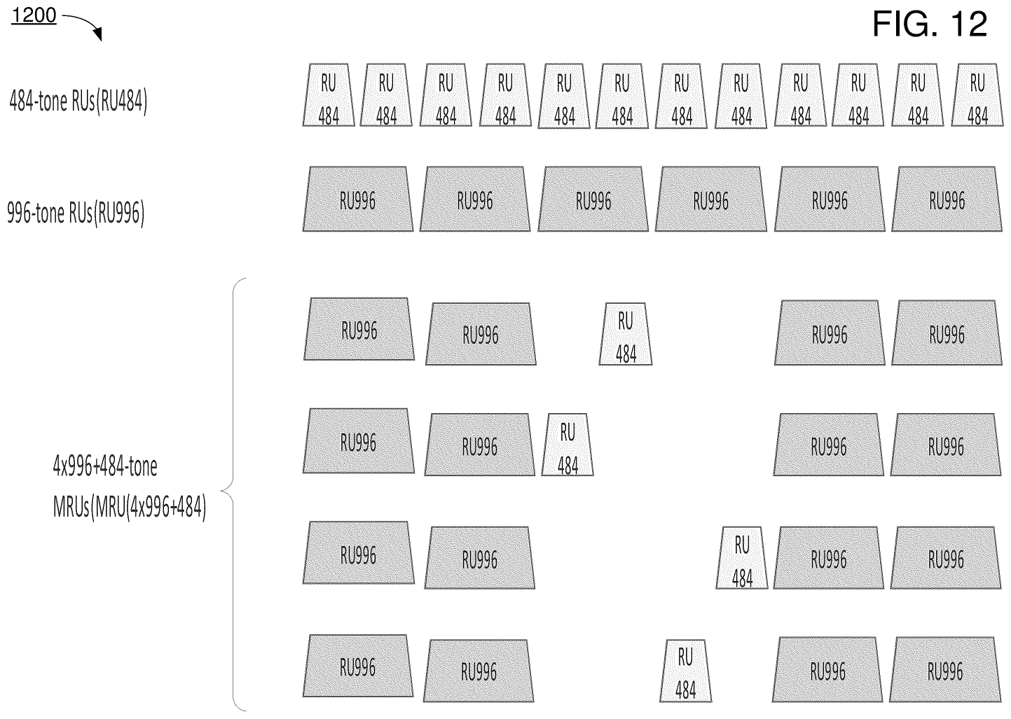

FIG. 12 illustrates an example scenario 1200 under a proposed scheme in accordance with the present disclosure. Scenario 1200 may pertain to MRU combination options for a wider bandwidth of 480 MHz. It is noteworthy that MRU combinations with either a one-hole puncture or two-hole punctures are considered and may be utilized under the proposed scheme. Referring to FIG. 12, in one option, upon to twelve 484-tone RUs may be modulated and transmitted over a 480 MHz bandwidth, with each RU484 occupying a respective 40 MHz frequency segment/frequency subblock. In another option, upon to six 996-tone RUs may be modulated and transmitted over the 480 MHz bandwidth, with each RU996 occupying a respective 80 MHz frequency segment/frequency subblock. In other options, MRU(4×996+484) may be modulated and transmitted over the 480 MHz bandwidth, with the RU484 occupying a respective 40 MHz frequency segment/frequency subblock and with each RU996 occupying a respective 80 MHz frequency segment/frequency subblock, resulting in a one-hole (120 MHz) puncture or a two-hole puncture of one 40 MHz puncture plus one 80 MHz puncture.

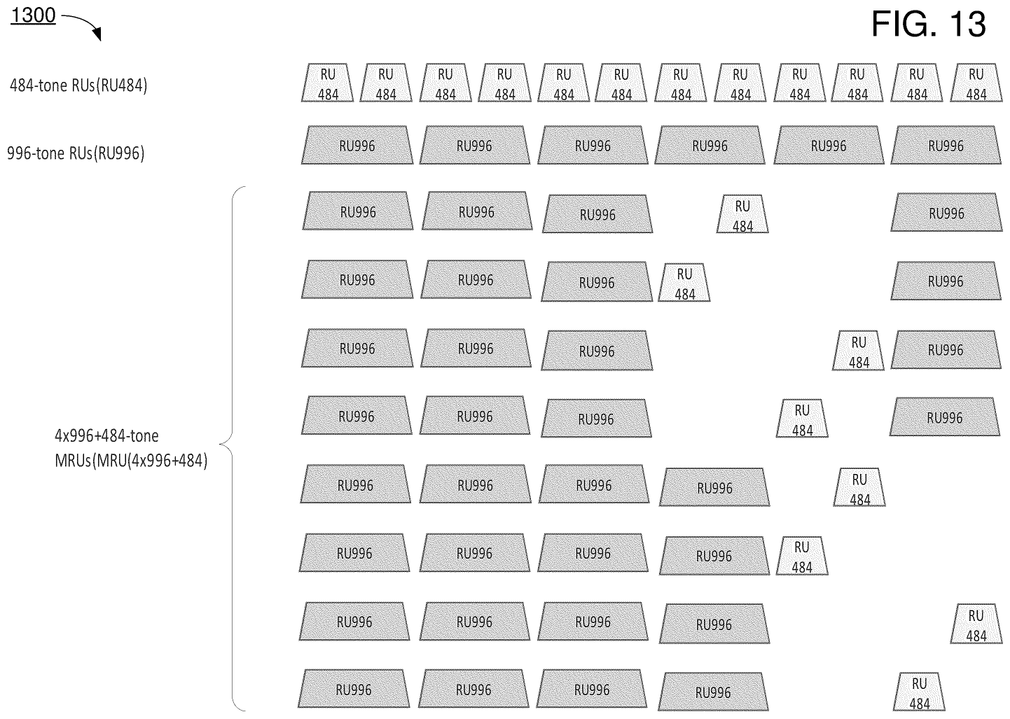

FIG. 13 illustrates an example scenario 1300 under a proposed scheme in accordance with the present disclosure. Scenario 1300 may pertain to MRU combination options for a wider bandwidth of 480 MHz. It is noteworthy that MRU combinations with either a one-hole puncture or two-hole punctures are considered and may be utilized under the proposed scheme. Referring to FIG. 13, in one option, upon to twelve 484-tone RUs may be modulated and transmitted over a 480 MHz bandwidth, with each RU484 occupying a respective 40 MHz frequency segment/frequency subblock. In another option, upon to six 996-tone RUs may be modulated and transmitted over the 480 MHz bandwidth, with each RU996 occupying a respective 80 MHZ frequency segment/frequency subblock. In other options, MRU(4×996+484) may be modulated and transmitted over the 480 MHz bandwidth, with the RU484 occupying a respective 40 MHz frequency segment/frequency subblock and with each RU996 occupying a respective 80 MHz frequency segment/frequency subblock, resulting in a one-hole (120 MHz) puncture or a two-hole puncture of one 40 MHz puncture plus one 80 MHz puncture.

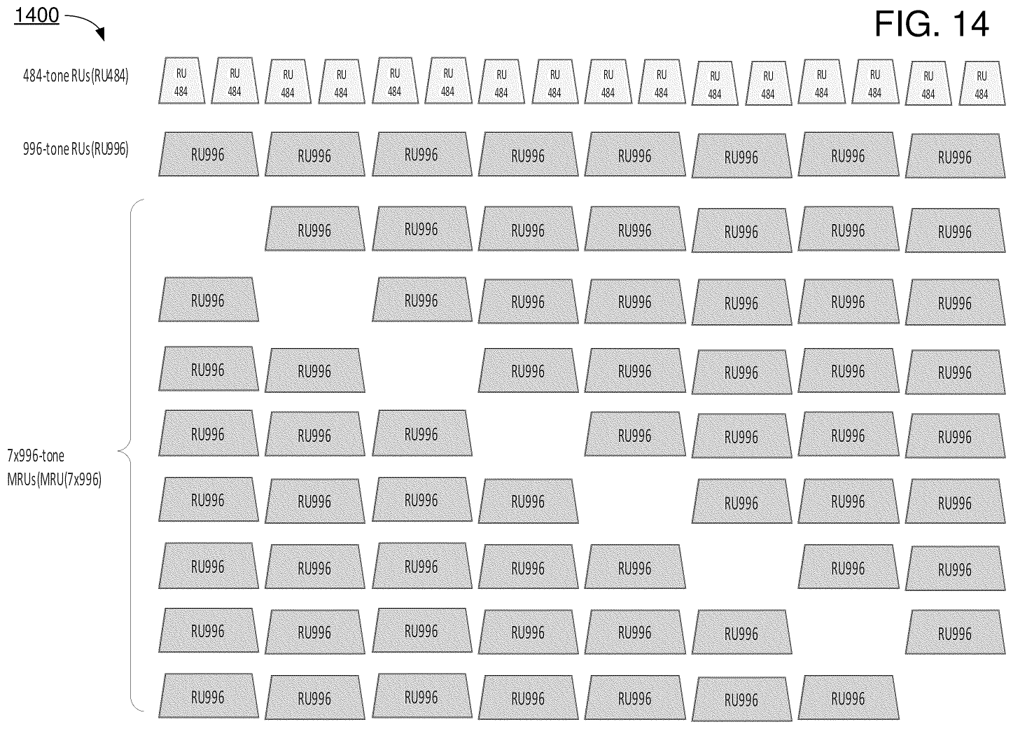

FIG. 14 illustrates an example scenario 1400 under a proposed scheme in accordance with the present disclosure. Scenario 1400 may pertain to MRU combination options for a wider bandwidth of 640 MHz. It is noteworthy that MRU combinations with either a one-hole puncture or two-hole punctures are considered and may be utilized under the proposed scheme. Referring to FIG. 14, in one option, upon to sixteen 484-tone RUs may be modulated and transmitted over a 640 MHz bandwidth, with each RU484 occupying a respective 40 MHz frequency segment/frequency subblock. In another option, upon to eight 996-tone RUs may be modulated and transmitted over the 640 MHz bandwidth, with each RU996 occupying a respective 80 MHz frequency segment/frequency subblock. In other options, MRU(7×996) may be modulated and transmitted over the 640 MHz bandwidth, with each RU996 occupying a respective 80 MHz frequency segment/frequency subblock, resulting in a one-hole (80 MHz) puncture.

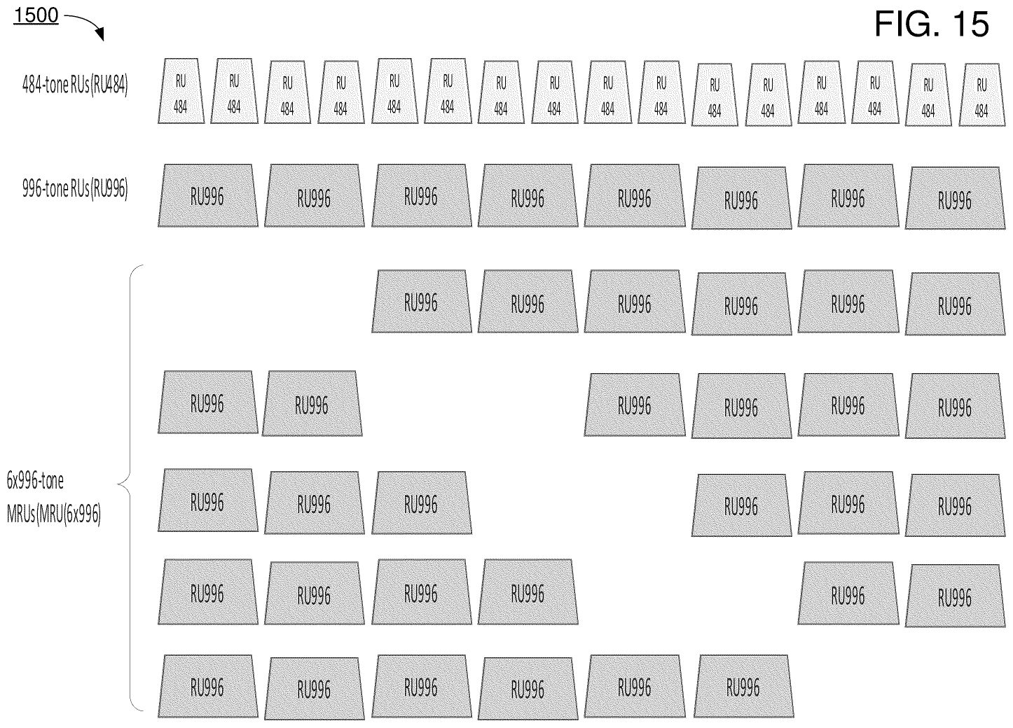

FIG. 15 illustrates an example scenario 1500 under a proposed scheme in accordance with the present disclosure. Scenario 1500 may pertain to MRU combination options for a wider bandwidth of 640 MHz. It is noteworthy that MRU combinations with either a one-hole puncture or two-hole punctures are considered and may be utilized under the proposed scheme. Referring to FIG. 15, in one option, upon to sixteen 484-tone RUs may be modulated and transmitted over a 640 MHz bandwidth, with each RU484 occupying a respective 40 MHz frequency segment/frequency subblock. In another option, upon to eight 996-tone RUs may be modulated and transmitted over the 640 MHz bandwidth, with each RU996 occupying a respective 80 MHz frequency segment/frequency subblock. In other options, MRU(6×996) may be modulated and transmitted over the 640 MHz bandwidth, with each RU996 occupying a respective 80 MHz frequency segment/frequency subblock, resulting in a one-hole (160 MHz) puncture.

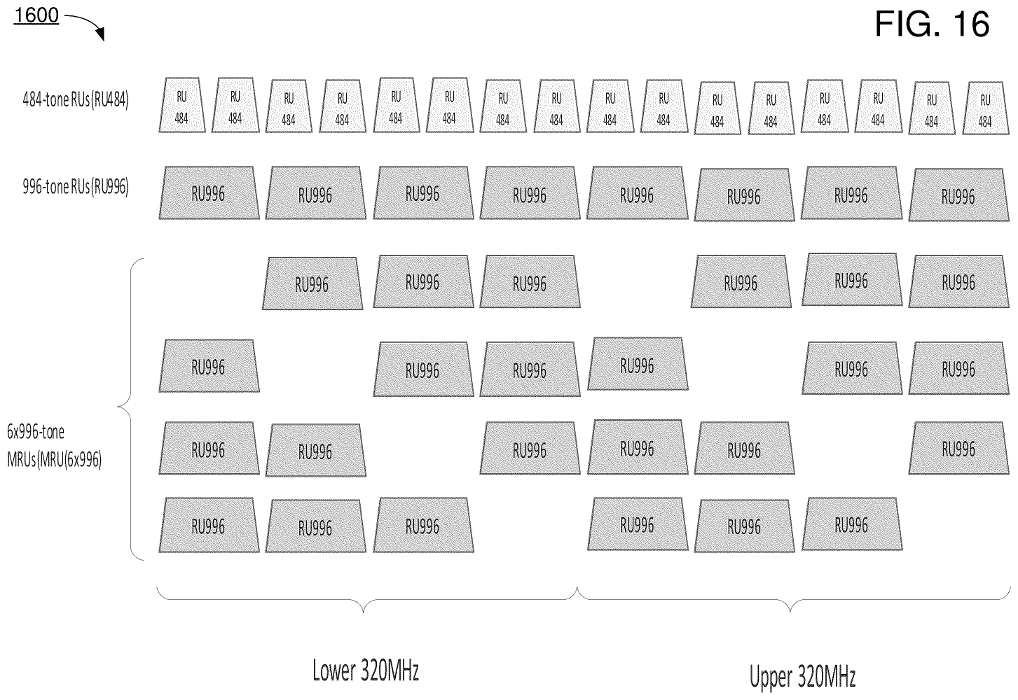

FIG. 16 illustrates an example scenario 1600 under a proposed scheme in accordance with the present disclosure. Scenario 1600 may pertain to MRU combination options for a wider bandwidth of 640 MHz. It is noteworthy that MRU combinations with either a one-hole puncture or two-hole punctures are considered and may be utilized under the proposed scheme. Referring to FIG. 16, in the case of 6×996-tone MRUs (or MRU(6×996)), any combination of MRU(3×996) on a lower 320 MHz segment and another MRU(3×996) on an upper 320 MHz segment may be feasible. Referring to FIG. 16, in one option, upon to sixteen 484-tone RUs may be modulated and transmitted over a 640 MHz bandwidth, with each RU484 occupying a respective 40 MHz frequency segment/frequency subblock. In another option, upon to eight 996-tone RUs may be modulated and transmitted over the 640 MHz bandwidth, with each RU996 occupying a respective 80 MHz frequency segment/frequency subblock. In other options, MRU(6×996) may be modulated and transmitted over the 640 MHz bandwidth, with each RU996 occupying a respective 80 MHz frequency segment/frequency subblock, resulting in a two-hole puncture of two 80 MHz punctures.

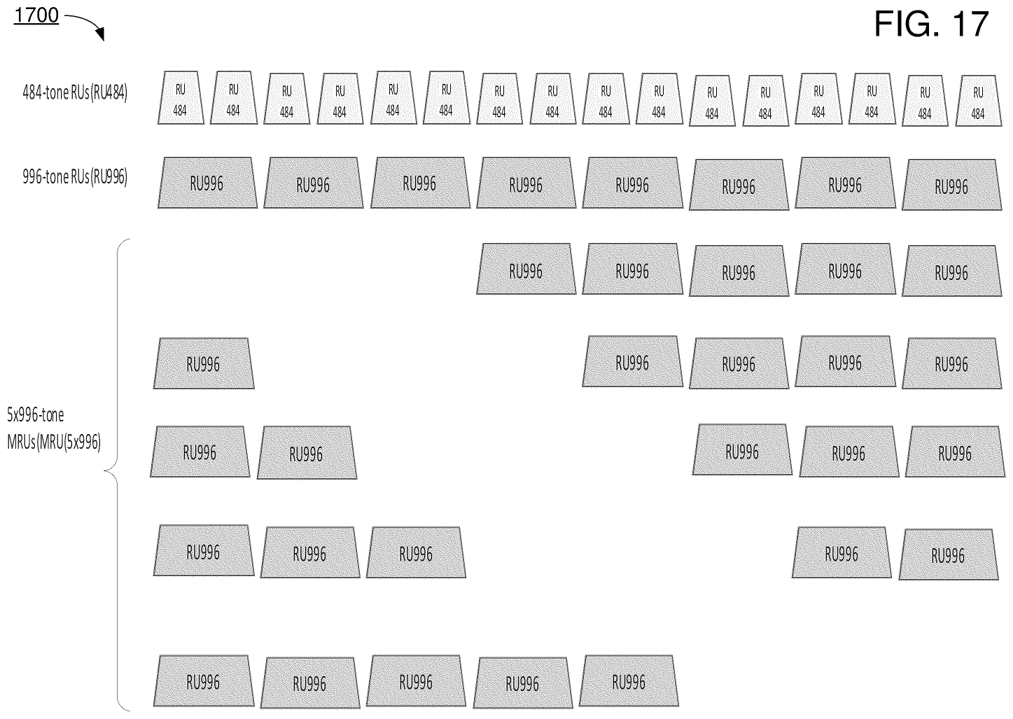

FIG. 17 illustrates an example scenario 1700 under a proposed scheme in accordance with the present disclosure. Scenario 1700 may pertain to MRU combination options for a wider bandwidth of 640 MHz. It is noteworthy that MRU combinations with either a one-hole puncture or two-hole punctures are considered and may be utilized under the proposed scheme. FIG. 17 illustrates an example scenario 1500 under a proposed scheme in accordance with the present disclosure. Scenario 1500 may pertain to MRU combination options for a wider bandwidth of 640 MHz. It is noteworthy that MRU combinations with either a one-hole puncture or two-hole punctures are considered and may be utilized under the proposed scheme. Referring to FIG. 17, in one option, upon to sixteen 484-tone RUs may be modulated and transmitted over a 640 MHz bandwidth, with each RU484 occupying a respective 40 MHz frequency segment/frequency subblock. In another option, upon to eight 996-tone RUs may be modulated and transmitted over the 640 MHz bandwidth, with each RU996 occupying a respective 80 MHz frequency segment/frequency subblock. In other options, MRU(5×996) may be modulated and transmitted over the 640 MHz bandwidth, with each RU996 occupying a respective 80 MHz frequency segment/frequency subblock, resulting in a one-hole (240 MHz) puncture.

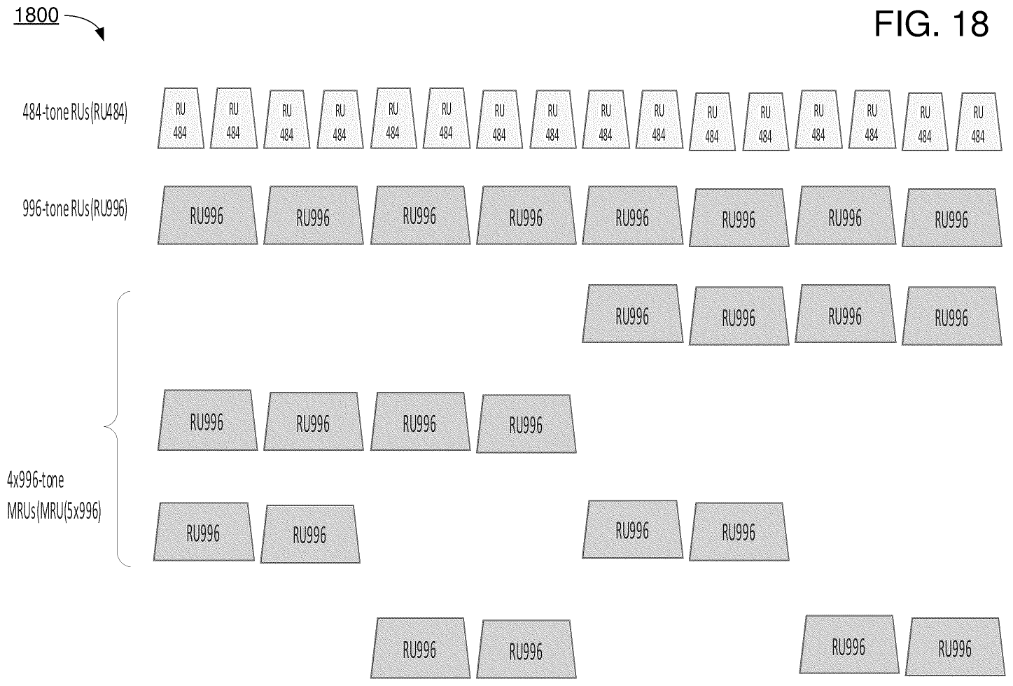

FIG. 18 illustrates an example scenario 1800 under a proposed scheme in accordance with the present disclosure. Scenario 1800 may pertain to MRU combination options for a wider bandwidth of 640 MHz. It is noteworthy that MRU combinations with either a one-hole puncture or two-hole punctures are considered and may be utilized under the proposed scheme. Referring to FIG. 18, in one option, upon to sixteen 484-tone RUs may be modulated and transmitted over a 640 MHz bandwidth, with each RU484 occupying a respective 40 MHz frequency segment/frequency subblock. In another option, upon to eight 996-tone RUs may be modulated and transmitted over the 640 MHz bandwidth, with each RU996 occupying a respective 80 MHz frequency segment/frequency subblock. In other options, MRU(4×996) may be modulated and transmitted over the 640 MHz bandwidth, with each RU996 occupying a respective 80 MHz frequency segment/frequency subblock, resulting in a one-hole (320 MHz) puncture or a two-hole puncture of two 160 MHz punctures.

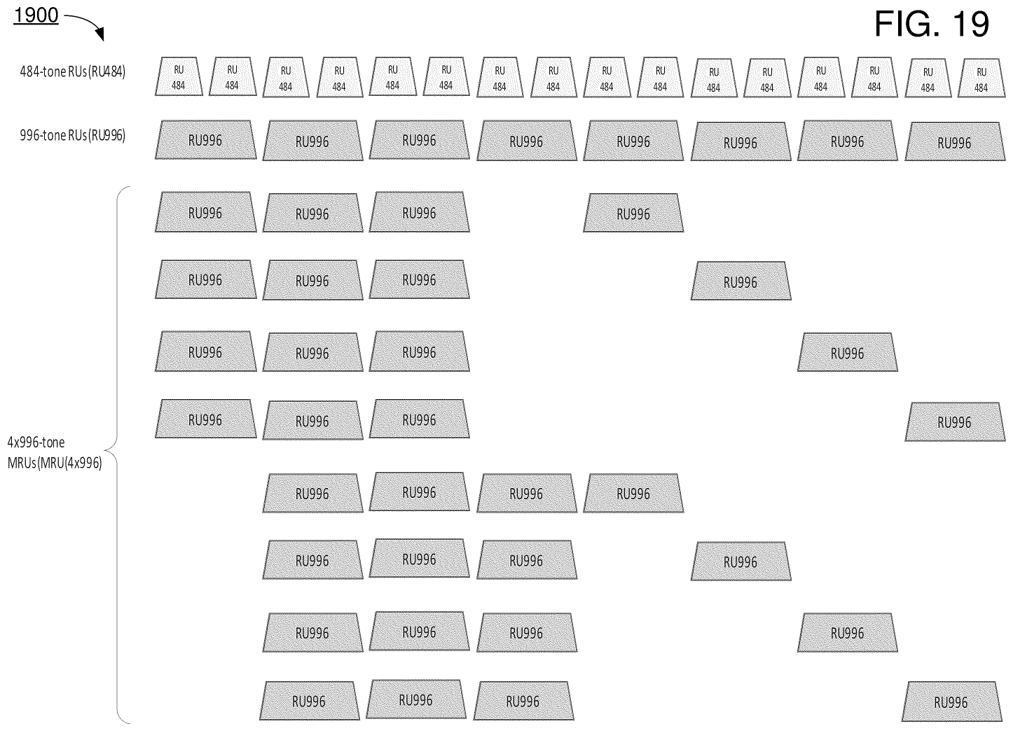

FIG. 19 illustrates an example scenario 1900 under a proposed scheme in accordance with the present disclosure. Scenario 1900 may pertain to MRU combination options for a wider bandwidth of 640 MHz. It is noteworthy that MRU combinations with either a one-hole puncture or two-hole punctures are considered and may be utilized under the proposed scheme. Referring to FIG. 19, in one option, upon to sixteen 484-tone RUs may be modulated and transmitted over a 640 MHz bandwidth, with each RU484 occupying a respective 40 MHz frequency segment/frequency subblock. In another option, upon to eight 996-tone RUs may be modulated and transmitted over the 640 MHz bandwidth, with each RU996 occupying a respective 80 MHz frequency segment/frequency subblock. In other options, MRU(4×996) may be modulated and transmitted over the 640 MHz bandwidth, with each RU996 occupying a respective 80 MHz frequency segment/frequency subblock, resulting in a one-hole (320 MHZ) puncture or a two-hole puncture of either: (i) two 160 MHz punctures or (ii) one 80 MHz puncture and one 240 MHz puncture.

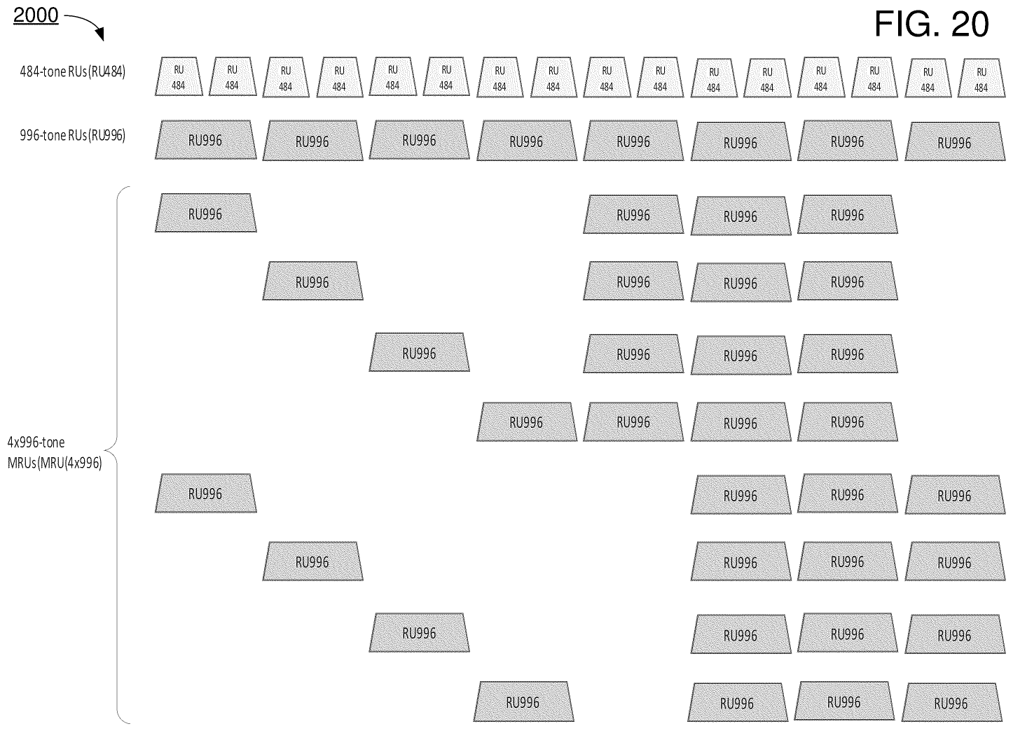

FIG. 20 illustrates an example scenario 2000 under a proposed scheme in accordance with the present disclosure. Scenario 2000 may pertain to MRU combination options for a wider bandwidth of 640 MHz. It is noteworthy that MRU combinations with either a one-hole puncture or two-hole punctures are considered and may be utilized under the proposed scheme. Referring to FIG. 20, in one option, upon to sixteen 484-tone RUs may be modulated and transmitted over a 640 MHz bandwidth, with each RU484 occupying a respective 40 MHz frequency segment/frequency subblock. In another option, upon to eight 996-tone RUs may be modulated and transmitted over the 640 MHz bandwidth, with each RU996 occupying a respective 80 MHz frequency segment/frequency subblock. In other options, MRU(4×996) may be modulated and transmitted over the 640 MHz bandwidth, with each RU996 occupying a respective 80 MHz frequency segment/frequency subblock, resulting in a one-hole (320 MHz) puncture or a two-hole puncture of either: (i) two 160 MHz punctures or (ii) one 80 MHz puncture and one 240 MHz puncture.

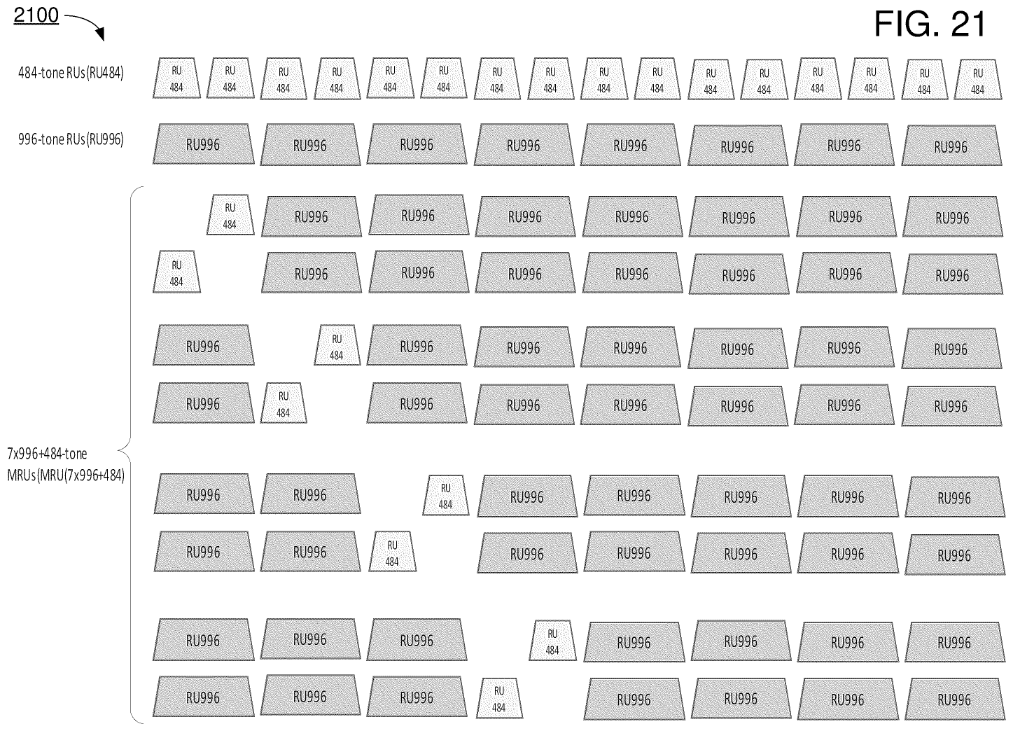

FIG. 21 illustrates an example scenario 2100 under a proposed scheme in accordance with the present disclosure. Scenario 2100 may pertain to MRU combination options for a wider bandwidth of 640 MHz. It is noteworthy that MRU combinations with either a one-hole puncture or two-hole punctures are considered and may be utilized under the proposed scheme. Referring to FIG. 21, in one option, upon to sixteen 484-tone RUs may be modulated and transmitted over a 640 MHz bandwidth, with each RU484 occupying a respective 40 MHz frequency segment/frequency subblock. In another option, upon to eight 996-tone RUs may be modulated and transmitted over the 640 MHz bandwidth, with each RU996 occupying a respective 80 MHz frequency segment/frequency subblock. In other options, MRU(7×996+484) may be modulated and transmitted over the 640 MHz bandwidth, with the RU484 occupying a respective 40 MHz frequency segment/frequency subblock and with each RU996 occupying a respective 80 MHz frequency segment/frequency subblock, resulting in a one-hole (40 MHz) puncture.

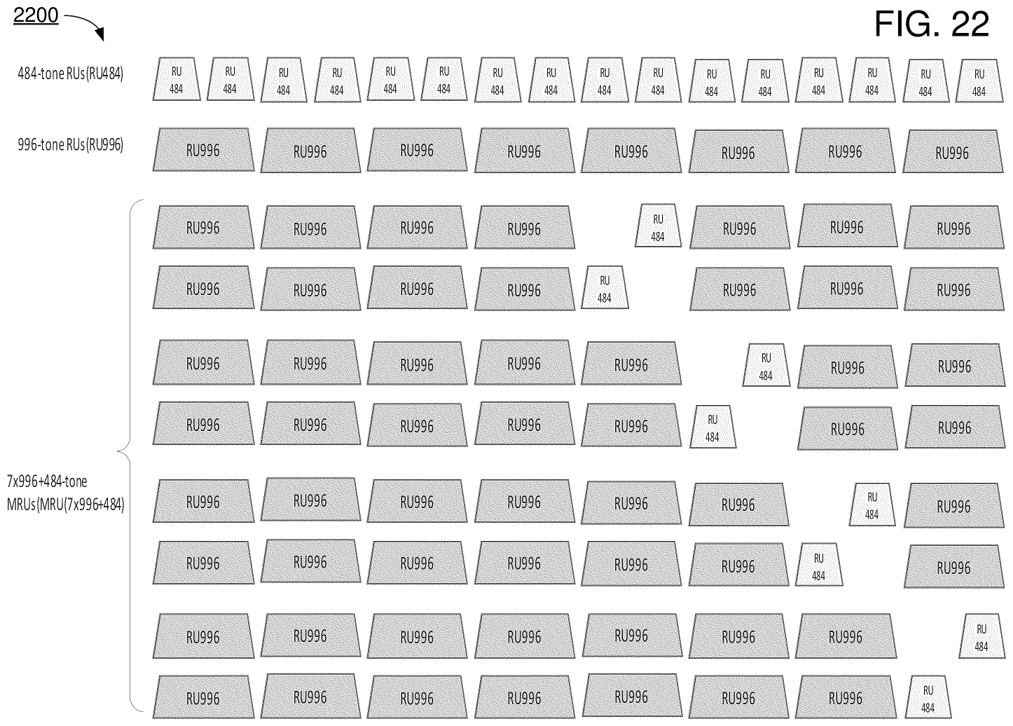

FIG. 22 illustrates an example scenario 2200 under a proposed scheme in accordance with the present disclosure. Scenario 2200 may pertain to MRU combination options for a wider bandwidth of 640 MHz. It is noteworthy that MRU combinations with either a one-hole puncture or two-hole punctures are considered and may be utilized under the proposed scheme. Referring to FIG. 22, in one option, upon to sixteen 484-tone RUs may be modulated and transmitted over a 640 MHz bandwidth, with each RU484 occupying a respective 40 MHz frequency segment/frequency subblock. In another option, upon to eight 996-tone RUs may be modulated and transmitted over the 640 MHz bandwidth, with each RU996 occupying a respective 80 MHz frequency segment/frequency subblock. In other options, MRU(7×996+484) may be modulated and transmitted over the 640 MHz bandwidth, with the RU484 occupying a respective 40 MHz frequency segment/frequency subblock and with each RU996 occupying a respective 80 MHz frequency segment/frequency subblock, resulting in a one-hole (40 MHz) puncture.

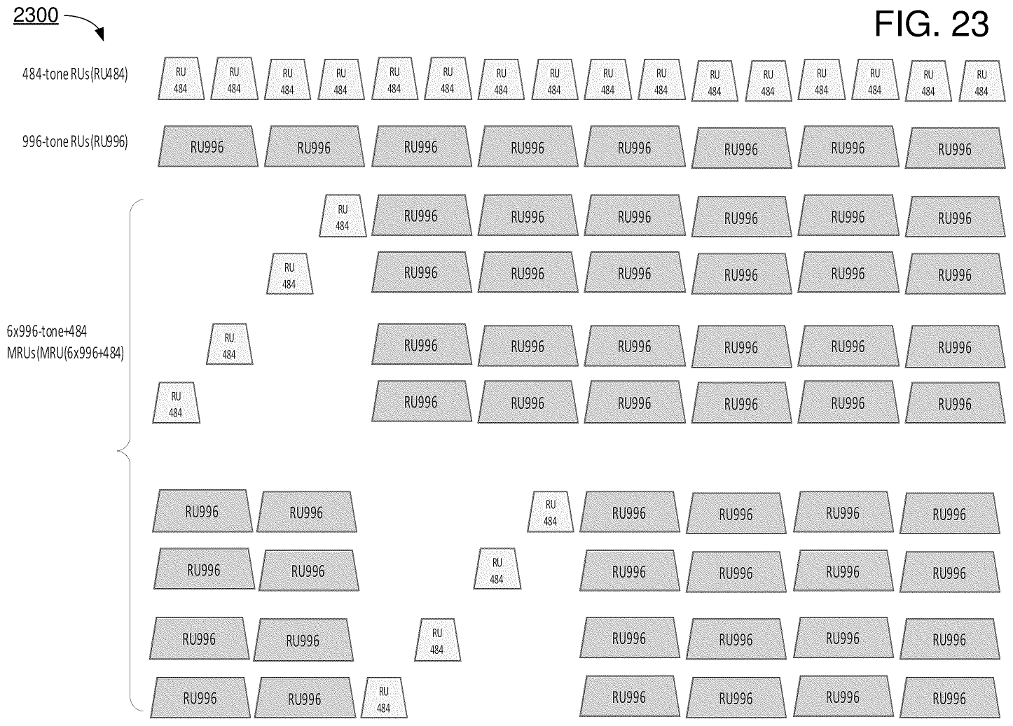

FIG. 23 illustrates an example scenario 2300 under a proposed scheme in accordance with the present disclosure. Scenario 2300 may pertain to MRU combination options for a wider bandwidth of 640 MHz. It is noteworthy that MRU combinations with either a one-hole puncture or two-hole punctures are considered and may be utilized under the proposed scheme. Referring to FIG. 23, in one option, upon to sixteen 484-tone RUs may be modulated and transmitted over a 640 MHz bandwidth, with each RU484 occupying a respective 40 MHz frequency segment/frequency subblock. In another option, upon to eight 996-tone RUs may be modulated and transmitted over the 640 MHz bandwidth, with each RU996 occupying a respective 80 MHz frequency segment/frequency subblock. In other options, MRU(6×996+484) may be modulated and transmitted over the 640 MHz bandwidth, with the RU484 occupying a respective 40 MHz frequency segment/frequency subblock and with each RU996 occupying a respective 80 MHz frequency segment/frequency subblock, resulting in a one-hole (120 MHz) puncture or a two-hole puncture of one 40 MHz puncture and one 80 MHz puncture.

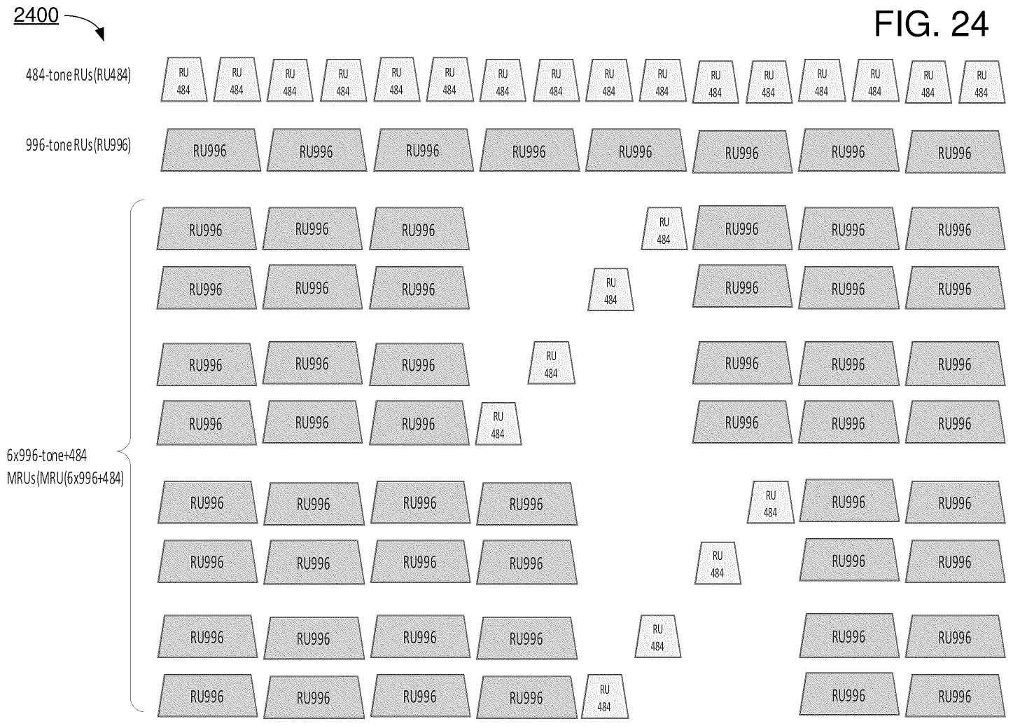

FIG. 24 illustrates an example scenario 2400 under a proposed scheme in accordance with the present disclosure. Scenario 2400 may pertain to MRU combination options for a wider bandwidth of 640 MHz. It is noteworthy that MRU combinations with either a one-hole puncture or two-hole punctures are considered and may be utilized under the proposed scheme. Referring to FIG. 24, in one option, upon to sixteen 484-tone RUs may be modulated and transmitted over a 640 MHz bandwidth, with each RU484 occupying a respective 40 MHz frequency segment/frequency subblock. In another option, upon to eight 996-tone RUs may be modulated and transmitted over the 640 MHz bandwidth, with each RU996 occupying a respective 80 MHz frequency segment/frequency subblock. In other options, MRU(6×996+484) may be modulated and transmitted over the 640 MHz bandwidth, with the RU484 occupying a respective 40 MHz frequency segment/frequency subblock and with each RU996 occupying a respective 80 MHz frequency segment/frequency subblock, resulting in a one-hole (120 MHz) puncture or a two-hole puncture of one 40 MHz puncture and one 80 MHz puncture.

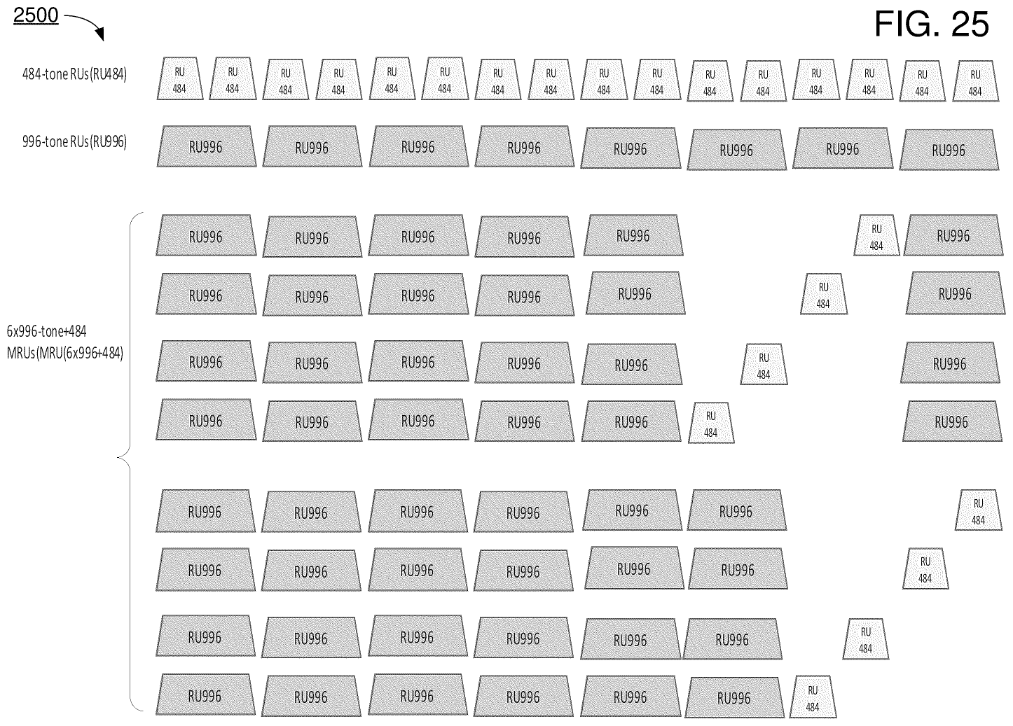

FIG. 25 illustrates an example scenario 2500 under a proposed scheme in accordance with the present disclosure. Scenario 2500 may pertain to MRU combination options for a wider bandwidth of 640 MHz. It is noteworthy that MRU combinations with either a one-hole puncture or two-hole punctures are considered and may be utilized under the proposed scheme. Referring to FIG. 25, in one option, upon to sixteen 484-tone RUs may be modulated and transmitted over a 640 MHz bandwidth, with each RU484 occupying a respective 40 MHz frequency segment/frequency subblock. In another option, upon to eight 996-tone RUs may be modulated and transmitted over the 640 MHz bandwidth, with each RU996 occupying a respective 80 MHz frequency segment/frequency subblock. In other options, MRU(6×996+484) may be modulated and transmitted over the 640 MHz bandwidth, with the RU484 occupying a respective 40 MHz frequency segment/frequency subblock and with each RU996 occupying a respective 80 MHz frequency segment/frequency subblock, resulting in a one-hole (120 MHz) puncture or a two-hole puncture of one 40 MHz puncture and one 80 MHz puncture.

### Illustrative Implementations

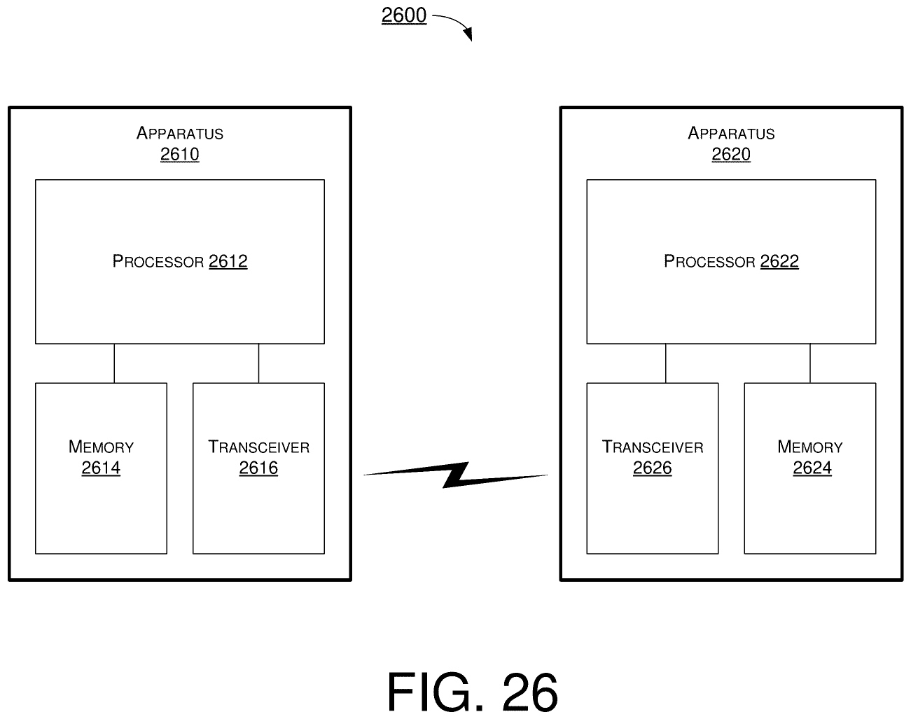

FIG. 26 illustrates an example system 2600 having at least an example apparatus 2610 and an example apparatus 2620 in accordance with an implementation of the present disclosure. Each of apparatus 2610 and apparatus 2620 may perform various functions to implement schemes, techniques, processes and methods described herein pertaining to proportional round robin segment parser designs for the wider bandwidths and corresponding MRU combinations with either EQM or UEQM in wireless communications, including the various schemes described above with respect to various proposed designs, concepts, schemes, systems and methods described above as well as processes described below. For instance, apparatus 2610 may be implemented in STA 110 and apparatus 2620 may be implemented in STA 120, or vice versa.

Each of apparatus 2610 and apparatus 2620 may be a part of an electronic apparatus, which may be a STA or an AP, such as a portable or mobile apparatus, a wearable apparatus, a wireless communication apparatus or a computing apparatus. When implemented in a STA, each of apparatus 2610 and apparatus 2620 may be implemented in a smartphone, a smart watch, a personal digital assistant, a digital camera, or a computing equipment such as a tablet computer, a laptop computer or a notebook computer. Each of apparatus 2610 and apparatus 2620 may also be a part of a machine type apparatus, which may be an loT apparatus such as an immobile or a stationary apparatus, a home apparatus, a wire communication apparatus or a computing apparatus. For instance, each of apparatus 2610 and apparatus 2620 may be implemented in a smart thermostat, a smart fridge, a smart door lock, a wireless speaker or a home control center. When implemented in or as a network apparatus, apparatus 2610 and/or apparatus 2620 may be implemented in a network node, such as an AP in a WLAN.

In some implementations, each of apparatus 2610 and apparatus 2620 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 2610 and apparatus 2620 may be implemented in or as a STA or an AP. Each of apparatus 2610 and apparatus 2620 may include at least some of those components shown in FIG. 26 such as a processor 2612 and a processor 2622, respectively, for example. Each of apparatus 2610 and apparatus 2620 may further include one or more other components not pertinent to the proposed scheme of the present disclosure (e.g., internal power supply, display device and/or user interface device), and, thus, such component(s) of apparatus 2610 and apparatus 2620 are neither shown in FIG. 26 nor described below in the interest of simplicity and brevity.

In one aspect, each of processor 2612 and processor 2622 may be implemented in the form of one or more single-core processors, one or more multi-core processors, one or more RISC processors or one or more CISC processors. That is, even though a singular term “a processor” is used herein to refer to processor 2612 and processor 2622, each of processor 2612 and processor 2622 may include multiple processors in some implementations and a single processor in other implementations in accordance with the present disclosure. In another aspect, each of processor 2612 and processor 2622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 2612 and processor 2622 is a special-purpose machine specifically designed, arranged and configured to perform specific tasks including those pertaining to proportional round robin segment parser designs for the wider bandwidths and corresponding MRU combinations with either EQM or UEQM in wireless communications in accordance with various implementations of the present disclosure.

In some implementations, apparatus 2610 may also include a transceiver 2616 coupled to processor 2612. Transceiver 2616 may include a transmitter capable of wirelessly transmitting and a receiver capable of wirelessly receiving data. In some implementations, apparatus 2620 may also include a transceiver 2626 coupled to processor 2622. Transceiver 2626 may include a transmitter capable of wirelessly transmitting and a receiver capable of wirelessly receiving data. It is noteworthy that, although transceiver 2616 and transceiver 2626 are illustrated as being external to and separate from processor 2612 and processor 2622, respectively, in some implementations, transceiver 2616 may be an integral part of processor 2612 as a system on chip (SoC) and/or transceiver 2626 may be an integral part of processor 2622 as a SoC.

In some implementations, apparatus 2610 may further include a memory 2614 coupled to processor 2612 and capable of being accessed by processor 2612 and storing data therein. In some implementations, apparatus 2620 may further include a memory 2624 coupled to processor 2622 and capable of being accessed by processor 2622 and storing data therein. Each of memory 2614 and memory 2624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 2614 and memory 2624 may include a type of read-only memory (ROM) such as mask ROM, programmable ROM (PROM), erasable programmable ROM (EPROM) and/or electrically erasable programmable ROM (EEPROM). Alternatively, or additionally, each of memory 2614 and memory 2624 may include a type of non-volatile random-access memory (NVRAM) such as flash memory, solid-state memory, ferroelectric RAM (FeRAM), magnetoresistive RAM (MRAM) and/or phase-change memory.

Each of apparatus 2610 and apparatus 2620 may be a communication entity capable of communicating with each other using various proposed schemes in accordance with the present disclosure. For illustrative purposes and without limitation, a description of capabilities of apparatus 2610, as STA 110, and apparatus 2620, as STA 120, is provided below in the context of process 2700. It is noteworthy that, although a detailed description of capabilities, functionalities and/or technical features of apparatus 2610 is provided below, the same may be applied to apparatus 2620 although a detailed description thereof is not provided solely in the interest of brevity. It is also noteworthy that, although the example implementations described below are provided in the context of WLAN, the same may be implemented in other types of networks.

### Illustrative Processes

FIG. 27 illustrates an example process 2700 in accordance with an implementation of the present disclosure. Process 2700 may represent an aspect of implementing various proposed designs, concepts, schemes, systems and methods described above. More specifically, process 2700 may represent an aspect of the proposed concepts and schemes pertaining to proportional round robin segment parser designs for the wider bandwidths and corresponding MRU combinations with either EQM or UEQM in wireless communications in accordance with the present disclosure. Process 2700 may include one or more operations, actions, or functions as illustrated by one or more of blocks 2710 and 2720. Although illustrated as discrete blocks, various blocks of process 2700 may be divided into additional blocks, combined into fewer blocks, or eliminated, depending on the desired implementation. Moreover, the blocks/sub-blocks of process 2700 may be executed in the order shown in FIG. 27 or, alternatively, in a different order. Furthermore, one or more of the blocks/sub-blocks of process 2700 may be executed repeatedly or iteratively. Process 2700 may be implemented by or in apparatus 2610 and apparatus 2620 as well as any variations thereof. Solely for illustrative purposes and without limiting the scope, process 2700 is described below in the context of apparatus 2610 implemented in or as STA 110 and apparatus 2620 implemented in or as STA 120 of a wireless network such as a WLAN in network environment 100 in accordance with one or more of IEEE 802.11 standards. It is noteworthy that, although the description of process 2700 below is provided in the context of apparatus 2610 (implemented in or as a non-AP STA) performing various operations, the same may be applicable to apparatus 2620 (implemented in or as an AP STA). Process 2700 may begin at block 2710.

At 2710, process 2700 may involve processor 2612 of apparatus 2610 (e.g., STA 110) generating an MRU comprising an aggregate of a plurality of RUs. Process 2700 may proceed from 2710 to 2720.

At 2720, process 2700 may involve processor 2612 transmitting, via transceiver 2616, the MRU with EQM or with UEQM in a bandwidth of 480 MHz or greater.

In some implementations, in generating the MRU, process 2700 may involve processor 2612 segment parsing data tones of the plurality of RUs of the MRU in a proportional round robin fashion with the EQM. In some implementations, in transmitting the MRU, process 2700 may involve processor 2612 transmitting the MRU with the EQM by applying a same modulation to the plurality of RUs across a plurality of frequency segments or frequency subblocks in the bandwidth.

In some implementations, in generating the MRU, process 2700 may involve processor 2612 segment parsing data tones of the plurality of RUs of the MRU in a proportional round robin fashion with the UEQM. In some implementations, in transmitting the MRU, process 2700 may involve processor 2612 transmitting the MRU with the UEQM by applying two or more different modulations to two or more RUs of the plurality of RUs across a plurality of frequency segments or frequency subblocks in the bandwidth.

In some implementations, in generating the MRU, process 2700 may involve processor 2612 generating: (a) twelve 484-tone RUs of the MRU to be transmitted in a 480 MHz bandwidth; or (b) six 996-tone RUs of the MUR to be transmitted in the 480 MHz bandwidth; or (c) sixteen 484-tone RUs of the MRU to be transmitted in a 640 MHz bandwidth; or (d) eight 996-tone RUs of the MUR to be transmitted in the 640 MHz bandwidth.

In some implementations, in generating the MRU, process 2700 may involve processor 2612 generating the MRU with a one-hole puncture (e.g., one continuous puncture). In such cases, the MRU may include: (a) five 996-tone RUs plus one 484-tone RU to be transmitted in a 480 MHz bandwidth; or (b) five 996-tone RUs to be transmitted in the 480 MHz bandwidth; or (c) four 996-tone RUs to be transmitted in the 480 MHz bandwidth; or (d) four 996-tone RUs plus one 484-tone RU to be transmitted in the 480 MHz bandwidth; or (e) seven 996-tone RUs to be transmitted in a 640 MHz bandwidth; or (f) six 996-tone RUs to be transmitted in the 640 MHz bandwidth; or (g) five 996-tone RUs to be transmitted in the 640 MHz bandwidth; or (h) four 996-tone RUs to be transmitted in the 640 MHz bandwidth; or (j) seven 996-tone RUs plus one 484-tone RU to be transmitted in the 640 MHz bandwidth; or (k) six 996-tone RUs plus one 484-tone RU to be transmitted in the 640 MHz bandwidth.

In some implementations, in generating the MRU, process 2700 may involve processor 2612 generating the MRU with a two-hole puncture (e.g., two discontinuous punctures). In such cases, the MRU may include: (a) four 996-tone RUs plus one 484-tone RU to be transmitted in a 480 MHz bandwidth; or (b) six 996-tone RUs to be transmitted in a 640 MHz bandwidth; or (c) four 996-tone RUs to be transmitted in the 640 MHz bandwidth; or (d) six 996-tone RUs plus one 484-tone RU to be transmitted in the 640 MHz bandwidth.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating a multi-resource unit (MRU) comprising an aggregate of a plurality of resource units (RUs); and
transmitting the MRU with equal modulation (EQM) or with unequal modulation (UEQM) in a bandwidth of 480 MHz or greater.

2. The method of claim 1, wherein the generating of the MRU comprises segment parsing data tones of the plurality of RUs of the MRU in a proportional round robin fashion with the EQM.

3. The method of claim 2, wherein the transmitting of the MRU comprises transmitting the MRU with the EQM by applying a same modulation to the plurality of RUs across a plurality of frequency segments or frequency subblocks in the bandwidth.

4. The method of claim 1, wherein the generating of the MRU comprises segment parsing data tones of the plurality of RUs of the MRU in a proportional round robin fashion with the UEQM.

5. The method of claim 4, wherein the transmitting of the MRU comprises transmitting the MRU with the UEQM by applying two or more different modulations to two or more RUs of the plurality of RUs across a plurality of frequency segments or frequency subblocks in the bandwidth.

6. The method of claim 1, wherein the generating of the MRU comprises generating:
twelve 484-tone RUs of the MRU to be transmitted in a 480 MHz bandwidth; or
six 996-tone RUs of the MUR to be transmitted in the 480 MHz bandwidth; or
sixteen 484-tone RUs of the MRU to be transmitted in a 640 MHz bandwidth; or
eight 996-tone RUs of the MUR to be transmitted in the 640 MHz bandwidth.

7. The method of claim 1, wherein the generating of the MRU comprises generating the MRU with a one-hole puncture.

8. The method of claim 7, wherein the MRU comprises:
five 996-tone RUs plus one 484-tone RU to be transmitted in a 480 MHz bandwidth; or
five 996-tone RUs to be transmitted in the 480 MHz bandwidth; or
four 996-tone RUs to be transmitted in the 480 MHz bandwidth; or
four 996-tone RUs plus one 484-tone RU to be transmitted in the 480 MHz bandwidth; or
seven 996-tone RUs to be transmitted in a 640 MHz bandwidth; or
six 996-tone RUs to be transmitted in the 640 MHz bandwidth; or
five 996-tone RUs to be transmitted in the 640 MHz bandwidth; or
four 996-tone RUs to be transmitted in the 640 MHz bandwidth; or
seven 996-tone RUs plus one 484-tone RU to be transmitted in the 640 MHz bandwidth; or
six 996-tone RUs plus one 484-tone RU to be transmitted in the 640 MHz bandwidth.

9. The method of claim 1, wherein the generating of the MRU comprises generating the MRU with a two-hole puncture.

10. The method of claim 9, wherein the MRU comprises:
four 996-tone RUs plus one 484-tone RU to be transmitted in a 480 MHz bandwidth; or
six 996-tone RUs to be transmitted in a 640 MHz bandwidth; or
four 996-tone RUs to be transmitted in the 640 MHz bandwidth; or
six 996-tone RUs plus one 484-tone RU to be transmitted in the 640 MHz bandwidth.

11. An apparatus, comprising:
a transceiver configured to communicate wirelessly; and
a processor coupled to the transceiver and configured to perform operations comprising:
generating a multi-resource unit (MRU) comprising an aggregate of a plurality of resource units (RUs); and
transmitting, via the transceiver, the MRU with equal modulation (EQM) or with unequal modulation (UEQM) in a bandwidth of 480 MHz or greater.

12. The apparatus of claim 11, wherein the generating of the MRU comprises segment parsing data tones of the plurality of RUs of the MRU in a proportional round robin fashion with the EQM.

13. The apparatus of claim 12, wherein the transmitting of the MRU comprises transmitting the MRU with the EQM by applying a same modulation to the plurality of RUs across a plurality of frequency segments or frequency subblocks in the bandwidth.

14. The apparatus of claim 11, wherein the generating of the MRU comprises segment parsing data tones of the plurality of RUs of the MRU in a proportional round robin fashion with the UEQM.

15. The apparatus of claim 14, wherein the transmitting of the MRU comprises transmitting the MRU with the UEQM by applying two or more different modulations to two or more RUs of the plurality of RUs across a plurality of frequency segments or frequency subblocks in the bandwidth.

16. The apparatus of claim 11, wherein the generating of the MRU comprises generating:
twelve 484-tone RUs of the MRU to be transmitted in a 480 MHz bandwidth; or
six 996-tone RUs of the MUR to be transmitted in the 480 MHz bandwidth; or
sixteen 484-tone RUs of the MRU to be transmitted in a 640 MHz bandwidth; or
eight 996-tone RUs of the MUR to be transmitted in the 640 MHz bandwidth.

17. The apparatus of claim 11, wherein the generating of the MRU comprises generating the MRU with a one-hole puncture.

18. The apparatus of claim 17, wherein the MRU comprises:
five 996-tone RUs plus one 484-tone RU to be transmitted in a 480 MHz bandwidth; or
five 996-tone RUs to be transmitted in the 480 MHz bandwidth; or
four 996-tone RUs to be transmitted in the 480 MHz bandwidth; or
four 996-tone RUs plus one 484-tone RU to be transmitted in the 480 MHz bandwidth; or
seven 996-tone RUs to be transmitted in a 640 MHz bandwidth; or
six 996-tone RUs to be transmitted in the 640 MHz bandwidth; or
five 996-tone RUs to be transmitted in the 640 MHz bandwidth; or
four 996-tone RUs to be transmitted in the 640 MHz bandwidth; or
seven 996-tone RUs plus one 484-tone RU to be transmitted in the 640 MHz bandwidth; or
six 996-tone RUs plus one 484-tone RU to be transmitted in the 640 MHz bandwidth.

19. The apparatus of claim 11, wherein the generating of the MRU comprises generating the MRU with a two-hole puncture.

20. The apparatus of claim 19, wherein the MRU comprises:
four 996-tone RUs plus one 484-tone RU to be transmitted in a 480 MHz bandwidth; or
six 996-tone RUs to be transmitted in a 640 MHz bandwidth; or
four 996-tone RUs to be transmitted in the 640 MHz bandwidth; or
six 996-tone RUs plus one 484-tone RU to be transmitted in the 640 MHz bandwidth.
